(19) United States
(12) Patent Application Publication
(10) Pub. No.: US 2015/0280981 A1
(43) Pub. Date: Oct. 1, 2015

(54) APPARATUS AND SYSTEM FOR CONFIGURATION MANAGEMENT

(71) Applicant: FUJITSU LIMITED, Kawasaki-shi (JP)

(72) Inventors: Takashi SASADA, Kobe (JP); Takayuki NAGAI, Harima (JP); Shigeru FUJIMOTO, Nishinomiya (JP)

(21) Appl. No.: 14/636,266

(22) Filed: Mar. 3, 2015

(30) Foreign Application Priority Data
Mar. 28, 2014 (JP) 2014-069382

(51) Int. Cl. H04L 12/24

(52) U.S. Cl. CPC H04L 41/0806

(57) ABSTRACT

A configuration management apparatus acquires a value of a configuration information item from a collection target apparatus to thereby manage the configuration of the collection target apparatus. To that end, the configuration management apparatus includes a determining unit and an acquiring unit. The determining unit determines an acquisition timing of acquiring the configuration information item based on at least one of reference frequency of the configuration information item being referred to, update frequency of the value of the configuration information item being updated, and load on the collection target apparatus in such a manner as to control the load on the collection target apparatus. The acquiring unit acquires the configuration information item from the collection target apparatus at the determined acquisition timing through cooperation with the collection target apparatus.

### CROSS-REFERENCE TO RELATED APPLICATION

This application is based upon and claims the benefit of priority of the prior Japanese Patent Application No. 2014-069382, filed on Mar. 28, 2014, the entire contents of which are incorporated herein by reference.

### FIELD

The embodiments discussed herein are related to a configuration management apparatus and a configuration management system to manage a configuration of a different system.

### BACKGROUND

Operations management of an information and communication technology (ICT) system (hereinafter, simply referred to as “system”) employs configuration information of the system. The configuration information refers to information of hardware resources of an apparatus, such as a computer, included in the system, information of software resources to run on the apparatus, and information indicating relationships between the information. For example, a configuration management apparatus collects configuration information from each apparatus in a management target system. Such a process of configuration information collection is sometimes called discovery. Apparatuses whose configuration information is collected in discovery are, for example, computers such as servers, terminal devices, and load balancers.

As for collecting configuration information, a technique has been proposed, for example, that makes an inquiry, in the case where configuration definitions reside on a directory server machine, to the directory server machine about whether an update has been made to a configuration definition according to a periodic timer event. Another proposed technique is directed to eliminating the need for inputting the interconnection relationship between network devices and communication lines as a database by monitoring the connection status and communication status by periodic transmission of polling commands and updating the content of a network connection management information recording unit.

As for updating configuration information, a technique has been proposed, for example, that carries out a process corresponding to a process request associated with a configuration item, which is information indicating a resource forming part of a system, at a different timing from when the process request is acquired and reflects, in the configuration item, attribute information included in the process request.

As for employing configuration information of a system, a technique has been proposed, for example, that uses information on configuration items and the like, acquired through a discovery process, to calculate an index value indicating processing costs or an environmental impact caused by a designated process or user. Another proposed technique is directed to using configuration item information collected from management data repository units, each included in a computer group located in a base, to prevent data concentration at the management data repository unit of a single base even when the amount of data increases.

Japanese Laid-open Patent Publication No. 2004-280838

Japanese Laid-open Patent Publication No. 05-199244

International Publication Pamphlet No. WO 2009/157062

International Publication Pamphlet No. WO 2010/047170

Japanese Laid-open Patent Publication No. 2012-53534

In many cases when configuration information acquired through a discovery process is used, the configuration information is the latest one. As for ensuring recency of configuration information to be used, there is a technique which acquires the latest one from a collection target apparatus when the configuration information is used (“acquisition-type” discovery). Another technique is to acquire, each time a change is made to the contents of configuration information in a collection target apparatus, the changed configuration information (“notification-type” discovery).

Note that frequent collection of configuration information through discovery processes results in increased load on a collection target apparatus. In view of this, a discovery method allowing fewer acquisitions of configuration information is adopted for each system. For example, the notification-type discovery may be adopted for a system where frequent reference to configuration information takes place while the acquisition-type discovery may be adopted for a system where configuration information is frequently updated.

However, conventionally a single discovery method designated for an entire system is applied to all configuration information items of the system. Therefore, if the usage or update situation of configuration information items of a collection target apparatus changes, the load on the collection target apparatus may increase more than expected. For example, if the frequencies of reference to the configuration information items increase more than expected when the acquisition-type discovery has been adopted under the assumption of less frequent reference, the number of discovery processes increases, thus putting excessive load on the collection target apparatus. On the other hand, if the update frequencies of the configuration information items increase more than expected when the notification-type discovery has been adopted under the assumption of less frequent updates, the number of discovery processes increases, thus putting excessive load on the collection target apparatus. Hence, the conventional technology is not effective to control the load attributable to the acquisition of the latest configuration information items in the case of changes in the reference frequencies or the update frequencies during operation.

### SUMMARY

According to one embodiment, there is provided a configuration management apparatus for managing the configuration of a collection target apparatus by acquiring a value of a configuration information item from the collection target apparatus. The configuration management apparatus includes a processor that performs a procedure including determining an acquisition timing of acquiring the configuration information item based on at least one of reference frequency of the configuration information item being referred to, update frequency of the value of the configuration information item being updated, and load on the collection target apparatus in such a manner as to control the load on the collection target apparatus; and acquiring the configuration information item from the collection target apparatus at the determined acquisition timing through cooperation with the collection target apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a system configuration according to a first embodiment;

FIG. 2 illustrates an example of a system configuration according to a second embodiment;

FIG. 3 illustrates an example of a hardware configuration of a configuration management server of the second embodiment;

FIG. 4 illustrates an example of applications of configuration information;

FIG. 5 is a block diagram illustrating functions of collecting the configuration information;

FIG. 6 illustrates an example of a CMDB;

FIG. 7 illustrates an example of a periodic discovery process;

FIG. 8 illustrates a practical example of the periodic discovery;

FIG. 9 illustrates an example of an acquisition-type discovery process;

FIG. 10 illustrates a practical example of the acquisition-type discovery;

FIG. 11 illustrates an example of a notification-type discovery process;

FIG. 12 illustrates a practical example of the notification-type discovery;

FIG. 13 illustrates an example of an intelligent discovery process;

FIG. 14 illustrates a practical example of the intelligent discovery;

FIG. 15 illustrates an example of criteria for determining a discovery method;

FIG. 16 illustrates an example of transitions of a discovery method according to changes in operational condition;

FIG. 17 is a block diagram illustrating functions of individual apparatuses according to the second embodiment;

FIG. 18 illustrates an example of a data structure of a reference database;

FIG. 19 is an example of a data structure of an update database;

FIG. 20 illustrates an example of a data structure of a discovery method storing unit;

FIG. 21 is an example of a data structure of a discovery method change log storing unit;

FIG. 22 illustrates an example of a data structure of a performance information storing unit;

FIG. 23 illustrates an example of a data structure of a notification-type discovery target storing unit in each collection target apparatus;

FIG. 24 is a flowchart illustrating an example of a procedure for a reference process;

FIG. 25 is a flowchart illustrating an example of a procedure for the notification-type discovery process;

FIG. 26 is a flowchart illustrating an example of a procedure for an update control process;

FIG. 27 is a flowchart illustrating an example of a procedure for the periodic discovery process;

FIG. 28 is a flowchart illustrating an example of a procedure for a performance monitoring cooperation process;

FIG. 29 illustrates an example of a CPU utilization history provided by a performance monitoring unit;

FIG. 30 is a flowchart illustrating an example of a procedure for a discovery method change process;

FIG. 31 is a first half of a flowchart illustrating an example of a procedure for a discovery method registration/update process; and

FIG. 32 is a second half of the flowchart illustrating the example of the procedure for the discovery method registration/update process.

### DESCRIPTION OF EMBODIMENTS

Several embodiments will be described below with reference to the accompanying drawings, wherein like reference numerals refer to like elements throughout. Note that two or more of the embodiments below may be combined for implementation in such a way that no contradiction arises.

### (a) First Embodiment

Next described is a first embodiment. The first embodiment is directed to dynamically changing the timing of acquiring configuration information from an apparatus in such a manner as to reduce the load placed on the apparatus due to the acquisition. Furthermore, according to the first embodiment, when there are a plurality of configuration information items, the acquisition timing is variable for each of the configuration information items.

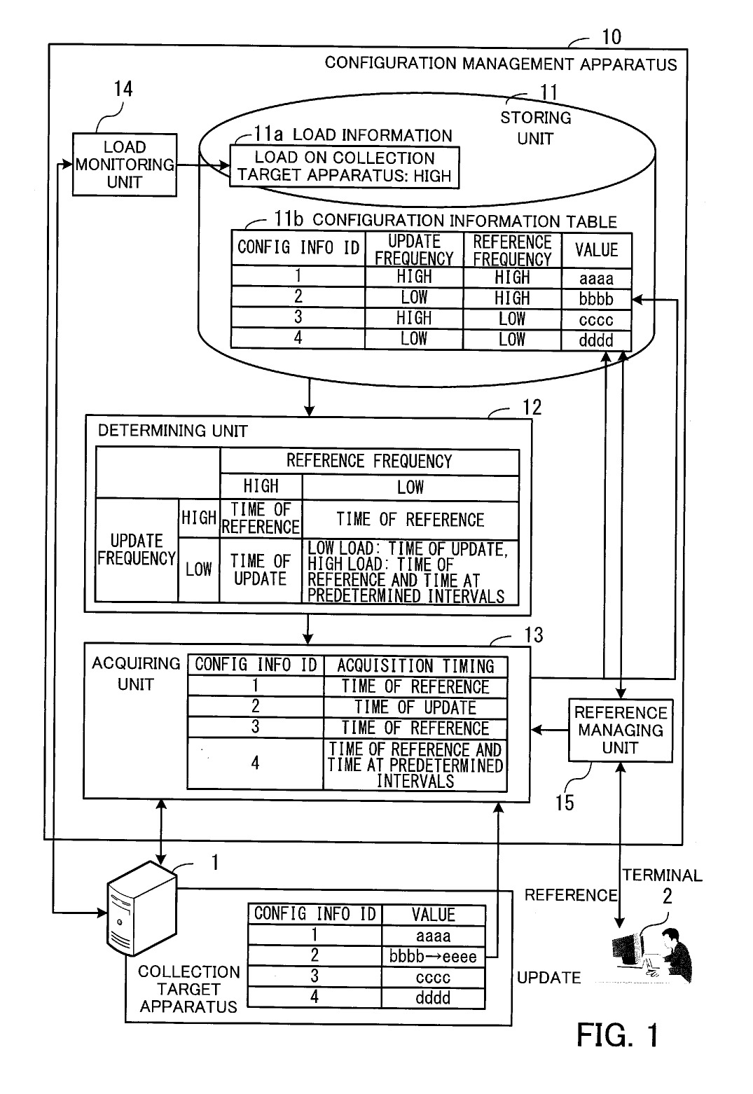

FIG. 1 illustrates an example of a system configuration according to a first embodiment. A configuration management apparatus 10 collects configuration information items of a collection target apparatus 1, and manages the configuration of the collection target apparatus 1 based on the configuration information items. The configuration information items collected by the configuration management apparatus 10 are available to be referred to from a terminal 2. The configuration management apparatus 10 includes a storing unit 11, a determining unit 12, an acquiring unit 13, a load monitoring unit 14, and a reference managing unit 15.

The storing unit 11 stores therein load information 11a and a configuration information table 11b. The load information 11a indicates the state of the load on the collection target apparatus 1. For example, the load information 11a indicates whether the load on the collection target apparatus 1 is higher or lower than a predetermined value. In the configuration information table 11b, update frequency, reference frequency, and a value are registered in association with a configuration information identifier (ID) assigned to each configuration information item. The update frequency is, for example, the number of times that the value of the configuration information item was updated per unit time. Alternatively, the time elapsed after the previous update of the configuration information item may be used as the update frequency. The reference frequency is, for example, the number of times that the configuration information item was referred to per unit time. Alternatively, the time elapsed after the previous reference to the configuration information item may be used as the reference frequency.

The determining unit 12 determines the timing of acquiring a configuration information item based on at least one of the reference frequency of the configuration information item, the update frequency of the configuration information item, and the load on the collection target apparatus 1 in such a manner as to control the load on the collection target apparatus 1. According to the example of FIG. 1, the determining unit 12 determines the timing of acquiring each configuration information item depending on the combination of the reference frequency of the configuration information item, the update frequency of the configuration information item, and the load on the collection target apparatus 1. Note that such a determination of the acquisition timing is made, for example, periodically at predetermined intervals.

Alternatively, the determining unit 12 may prepare in advance a plurality of definition information pieces each indicating a timing of configuration information acquisition and select, amongst the definition information pieces, a definition information piece to be applied to a configuration information item, to thereby determine the acquisition timing. For example, a definition information piece defines the time when a request to refer to a configuration information item is input as the timing of acquiring the configuration information item. In addition, another definition information piece may define the time when the value of a configuration information item is updated as the timing of acquiring the configuration information item. Furthermore, a yet another definition information piece may define the time according to a predetermined schedule and the time when a request to refer to a configuration information item is input as the timings of acquiring the configuration information item.

Through cooperation with the collection target apparatus 1, the acquiring unit 13 acquires a configuration information item from the collection target apparatus 1 at the timing determined by the determining unit 12. For example, upon receiving, from the reference managing unit 15, notification that a reference request for a configuration information item to be acquired at the time of reference has been made, the acquiring unit 13 acquires the configuration information item from the collection target apparatus 1. In addition, the acquiring unit 13 designates each configuration information item to be acquired at the time of update and instructs the collection target apparatus 1 to monitor whether the configuration information item is updated. In response, when the value of a designated configuration information item is updated, the collection target apparatus 1 transmits the updated configuration information item to the configuration management apparatus 10. As for each configuration information item determined to be acquired at the time fixed by a schedule (for example, at predetermined intervals), the acquiring unit 13 acquires the configuration information item from the collection target apparatus 1 at the fixed time. The acquiring unit 13 sets the value of the acquired configuration information item in the configuration information table 11b of the storing unit 11.

Further, the acquiring unit 13 calculates update frequency of each configuration information item and sets information indicating the update frequency in the configuration information table 11b. For example, in the case where the value of an acquired configuration information item is different from one registered in the configuration information table 11b until just before the acquisition, the acquiring unit 13 determines that the configuration information item has been updated. Then, the acquiring unit 13 calculates the update frequency for each configuration information item, and sets “HIGH” for the update frequency of the configuration information item in the configuration information table 11b when the update frequency is more than a predetermined value. On the other hand, if the update frequency is less than or equal to the predetermined value, the acquiring unit 13 sets “LOW” for the update frequency of the configuration information item in the configuration information table 11b.

The load monitoring unit 14 monitors load placed on the collection target apparatus 1. For example, the load monitoring unit 14 acquires central processing unit (CPU) or memory utilization from the collection target apparatus 1. Then, the load monitoring unit 14 determines the load on the collection target apparatus 1 based on the acquired information, and sets “HIGH” in the load information 11a when the load exceeds a predetermined value. On the other hand, if the load is less than or equal to the predetermined value, the load monitoring unit 14 sets “LOW” in the load information 11a.

In response to a reference request of the terminal 2 for a configuration information item, the reference managing unit 15 acquires the configuration information item from the storing unit 11, and returns the acquired configuration information item to the terminal 2. In the case where the acquisition timing of the reference-requested configuration information item has been determined as the time of reference, the reference managing unit 15 notifies the acquiring unit 13 of the reception of the reference request for the configuration information item. Subsequently, after the latest configuration information item is acquired by the acquiring unit 13, the reference management unit 15 acquires the reference-requested configuration information item from the storing unit 11.

In addition, the reference managing unit 15 calculates the reference frequency of each configuration information item and sets information indicating the reference frequency in the configuration information table 11b. For example, the reference managing unit 15 calculates the reference frequency for each configuration information item, and sets “HIGH” for the reference frequency of the configuration information item in the configuration information table 11b when the reference frequency is more than a predetermined value. On the other hand, if the reference frequency is less than or equal to the predetermined value, the reference managing unit 15 sets “LOW” for the reference frequency of the configuration information item in the configuration information table 11b.

In the system with above-described configuration, as for the update frequency of each configuration information item, a value according to the latest situation is set by the acquiring unit 13. As for the reference frequency of each configuration information item, a value according to the latest situation is set by the reference managing unit 15. As for the load information 11a, a value according to the latest situation is set by the load monitoring unit 14. Under such a condition, the determining unit 12 determines the acquisition timing for each configuration information item at a predetermined timing. For example, in the case where both the update and reference frequencies of a configuration information item are high, the timing of acquiring the configuration information item is determined to be the time of reference. In the case where the update frequency of a configuration information item is high but the reference frequency is low, the timing of acquiring the configuration information item is determined to be the time of reference. In the case where the update frequency of a configuration information item is low but the reference frequency is high, the timing of acquiring the configuration information item is determined to be the time of update. In the case where both the update and reference frequencies of a configuration information item are low, if the load on the collection target apparatus 1 is low, the timing of acquiring the configuration information item is determined to be the time of update. On the other hand, if the load on the collection target apparatus 1 is high, the timing of acquiring the configuration information item is determined to be the time of reference and the time at predetermined intervals.

The acquiring unit 13 is notified of the acquisition timing of each configuration information item determined by the determining unit 12. The acquiring unit acquires the latest value of each configuration information item at the notified acquisition timing. According to the example of FIG. 1, the acquisition timing of a configuration information item with a configuration information identifier of “1” is the time of reference. Therefore, each time a reference is made to the configuration information item with the configuration information identifier “1”, the acquiring unit 13 acquires the latest value of the configuration information item from the collection target apparatus 1. Then, the acquiring unit 13 sets the acquired latest value of the configuration information item in the configuration information table 11b.

In addition, according to the example of FIG. 1, the acquisition timing of a configuration information item with a configuration information identifier of “2” is the time of update. Therefore, the acquiring unit 13 requests the collection target apparatus 1 to monitor the configuration information item with the configuration information identifier “2”. Then, the collection target apparatus 1 monitors the presence or absence of a change in the value of the configuration information item with the configuration information identifier “2”. When a change is made to the value, the collection target apparatus 1 transmits the configuration information item with the changed value to the configuration management apparatus 10. The transmitted configuration information item is received by the acquiring unit 13 and set in the configuration information table 11b of the storing unit 11.

Further, according to the example of FIG. 1, the acquisition timing of a configuration information item with a configuration information identifier of “4” is the time of reference and the time at predetermined intervals. Therefore, each time reference is made to the configuration information item with the configuration information identifier “4”, the acquiring unit 13 acquires the latest value of the configuration information item from the collection target apparatus 1. In addition, the acquiring unit 13 acquires the latest value of the configuration information item from the collection target apparatus 1 at predetermined intervals regardless of whether reference is made to the configuration information item. Subsequently, the acquiring unit 13 sets the acquired latest value of the configuration information item in the configuration information table 11b.

Thus, in response to the reference request from the terminal 2, the configuration management apparatus 10 is able to send the latest value of the requested configuration information item to the terminal 2. Furthermore, the acquisition timing of each configuration information item is dynamically changed according to the situation at the time. For example, as for a configuration information item the acquisition timing of which is the time of update because both the update and reference frequencies were low, the acquisition timing is changed to the time of reference when the update frequency has become high. As a result, the number of acquisitions of the configuration information item is controlled, reducing the load placed on the collection target apparatus 1 due to the acquisitions. This also alleviates the load on the configuration management apparatus 10.

Note that according to the example of FIG. 1, the acquisition timing is determined based on the combination of the update frequency (change attribute), the reference frequency (usage attribute), and the load on the collection target apparatus 1 (load attribute); however, the acquisition timing may be determined based on one of the above attributes.

The determining unit 12 may determine the acquisition timing of a configuration information item, for example, based only on the update frequency of the configuration information item. For example, when the update frequency of a configuration information item is higher than a predetermined value, the determining unit 12 determines that the time when a request to refer to the configuration information item is input is the timing of acquiring the configuration information item. On the other hand, when the update frequency of the configuration information item is equal to or lower than a predetermined value, the determining unit 12 determines that the time when the value of the configuration information item is updated is the timing of acquiring the configuration information item. Herewith, when the update frequency of a configuration information item is high, the configuration information item is acquired at the time of reference, thereby reducing the number of acquisitions of the configuration information item.

In addition, the determining unit 12 may determine the acquisition timing of a configuration information item, for example, based only on the reference frequency of the configuration information item. For example, when the reference frequency of a configuration information item is equal to or lower than a predetermined value, the determining unit 12 determines that the time according to a predetermined schedule and the time when a request to refer to the configuration information item is input are the timings of acquiring the configuration information item. On the other hand, when the reference frequency of the configuration information item is higher than the predetermined value, the determining unit 12 determines that the time when the value of the configuration information item is updated is the timing of acquiring the configuration information item. Herewith, when the reference frequency of a configuration information item is high, the configuration information item is acquired at the time of update, thereby reducing the number of acquisitions of the configuration information item. Note that when the reference frequency of a configuration information item is equal to or lower than a predetermined value, the determining unit 12 may determine that only the time when a request to refer to the configuration information item is input is the timing of acquiring the configuration information item.

Further, the determining unit 12 may determine the acquisition timing of a configuration information item, for example, based only on the load on the collection target apparatus 1. For example, when the load on the collection target apparatus 1 is higher than a predetermined value, the determining unit 12 determines that the time according to a predetermined schedule and the time when a request to refer to the configuration information item is input are the timings of acquiring the configuration information item. On the other hand, when the load on the collection target apparatus 1 is equal to or lower than the predetermined value, the determining unit 12 determines that the time when the value of the configuration information item is updated is the timing of acquiring the configuration information item. Herewith, when the collection target apparatus 1 is placed under high load, a configuration information item is acquired at the time of reference. This reduces the workload of the collection target apparatus 1 to monitor whether the configuration information item has been updated, thus alleviating the load on the collection target apparatus 1.

When the load on the collection target apparatus 1 is expected to become excessively high, the determining unit 12 may not increase the number of configuration information items the acquisition timing of which is the time of update any more. For example, based on a change in the number of configuration information items the acquisition timing of which is the time of update amongst a plurality of configuration information items and a change in the load on the collection target apparatus 1, the determining unit 12 calculates the amount of load to be placed on the collection target apparatus 1 when the number of configuration information items increases by one. Then, in the case where a value obtained by adding the calculated amount of load to the current load on the collection target apparatus 1 becomes equal to or lower than a predetermined value, the determining unit 12 keeps the number of configuration information items whose acquisition timing is the time of update from increasing. This prevents the collection target apparatus 1 from being put under excessive load due to an increase in the number of configuration information items whose acquisition timing is the time of update.

Note that the configuration management apparatus 10 may be implemented, for example, by causing a computer to execute a program. The determining unit 12, the acquiring unit 13, the load monitoring unit 14, and the reference managing unit 15 may be implemented, for example, by a processor of the configuration management apparatus 10. The storing unit 11 may be implemented, for example, by memory of the configuration management apparatus 10. In FIG. 1, each line connecting the individual components represents a part of communication paths, and communication paths other than those illustrated in FIG. 1 are also configurable.

### (b) Second Embodiment

A second embodiment is described next. The second embodiment is directed to that a server carries out discovery processes (acquisitions of configuration information items) on a plurality of apparatuses using discovery methods that ensure both load reduction for an entire system and recency of the configuration information items.

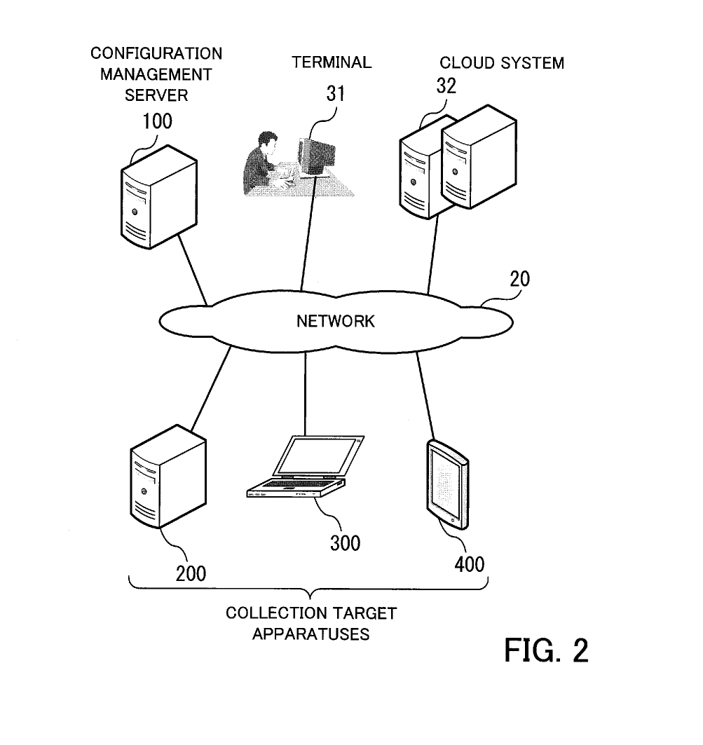

FIG. 2 illustrates an example of a system configuration according to the second embodiment. A configuration management server 100, a terminal 31, a cloud system 32, collection target apparatuses 200, 300, and 400 are connected to each other via a network 20. The configuration management server 100 collects configuration information items from the collection target apparatuses 200, 300, and 400 and manages the configuration of each of the apparatuses 200, 300, and 400. Examples of the collection target apparatuses 200, 300, and 400 are a server computer, a laptop computer, and a personal digital assistance such as a smartphone.

According to an input from a user, the terminal transmits a request to refer to a configuration information item to the configuration management server 100. Then, the terminal 31 displays, on a monitor, the configuration information item returned from the configuration management server 100 in response to the request. Alternatively, the terminal 31 analyzes the acquired configuration information item using application software and displays the analysis result on the monitor.

The cloud system 32 provides system management service supported, for example, by analyses of configuration information of the system. In this regard, the cloud system 32 transmits reference requests for configuration information items to the configuration management server 100 to thereby acquire the configuration information items from the configuration management server 100. Subsequently, based on the acquired configuration information items, the cloud system 32 analyzes the operational condition and the like of the system.

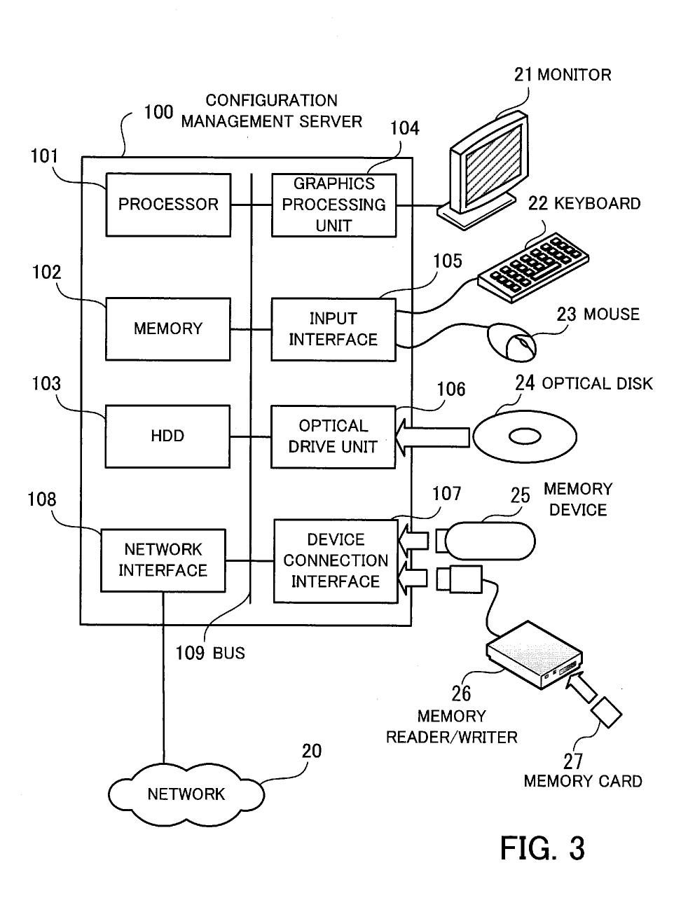

FIG. 3 illustrates an example of a hardware configuration of a configuration management server of the second embodiment. Overall control of the configuration management server 100 is exercised by a processor 101. To the processor 101, memory 102 and a plurality of peripherals are connected via a bus 109. The processor 101 may be a multi-processor. The processor 101 is, for example, a CPU, a micro processing unit (MPU), or a digital signal processor (DSP). At least part of the functions implemented by executing a program by the processor 101 may be implemented as an electronic circuit, such as an application specific integrated circuit (ASIC) and a programmable logic device (PLD).

The memory 102 is used as a main storage device of the configuration management server 100. The memory 102 temporarily stores at least part of an operating system (OS) program and application programs to be executed by the processor 101. The memory 102 also stores therein various types of data to be used by the processor 101 for its processing. As the memory 102, a volatile semiconductor storage device such as a random access memory (RAM) may be used.

The peripherals connected to the bus 109 include a hard disk drive (HDD) 103, a graphics processing unit 104, an input interface 105, an optical drive unit 106, a device connection interface 107, and a network interface 108. The HDD 103 magnetically writes and reads data to and from a built-in disk, and is used as a secondary storage device of the configuration management server 100. The HDD 103 stores therein the OS program, application programs, and various types of data. Note that a non-volatile semiconductor storage device such as a flash memory may be used as a secondary storage device in place of the HDD 103.

To the graphics processing unit 104, a monitor is connected. According to an instruction from the processor 101, the graphics processing unit 104 displays an image on a screen of the monitor 21. A cathode ray tube (CRT) display or a liquid crystal display, for example, may be used as the monitor 21. To the input interface 105, a keyboard 22 and a mouse 23 are connected. The input interface 105 transmits signals sent from the keyboard 22 and the mouse 23 to the processor 101. Note that the mouse 23 is just an example of pointing devices, and a different pointing device such as a touch panel, a tablet, a touch-pad, and a track ball, may be used instead.

The optical drive unit 106 reads data recorded on an optical disk 24 using, for example, laser light. The optical disk 24 is a portable storage medium on which data is recorded in such a manner as to be read by reflection of light. Examples of the optical disk 24 include a digital versatile disc (DVD), a DVD-RAM, a compact disk read only memory (CD-ROM), a CD recordable (CD-R), and a CD-rewritable (CD-RW).

The device connection interface 107 is a communication interface for connecting peripherals to the configuration management server 100. To the device connection interface 107, for example, a memory device 25 and a memory reader/writer 26 may be connected. The memory device 25 is a storage medium having a function for communicating with the device connection interface 107. The memory reader/writer 26 is a device for writing and reading data to and from a memory card 27 which is a card type storage medium. The network interface 108 is connected to the network 20. Via the network 20, the network interface 108 transmits and receives data to and from different computers and communication devices.

The hardware configuration described above achieves the processing functions of the second embodiment. Note that FIG. 3 illustrates the hardware configuration of the configuration management server 100; however, each of the terminal 31, computers making up the cloud system 32, and the collection target apparatuses 200, 300, and 400 may be built with the same hardware configuration as the configuration management server 100. In addition, each of the configuration management apparatus 10, the collection target apparatus 1, and the terminal 2 of the first embodiment may also be built with the same hardware configuration as the configuration management server 100 of FIG. 3.

The configuration management server 100 achieves the processing functions of the second embodiment, for example, by executing a program stored in a computer-readable storage medium. The program describing processing contents to be implemented by the configuration management server 100 may be stored in various types of storage media. For example, the program to be executed by the configuration management server 100 may be stored in the HDD 103. The processor 101 loads at least part of the program stored in the HDD 103 into the memory 102 and then runs the program. In addition, the program to be executed by the configuration management server 100 may be stored in a portable storage medium, such as the optical disk 24, the memory device 25, and the memory card 27. The program stored in the portable storage medium becomes executable after being installed on the HDD 103, for example, under the control of the processor 101. Alternatively, the processor 101 may run the program by directly reading it from the portable storage medium.

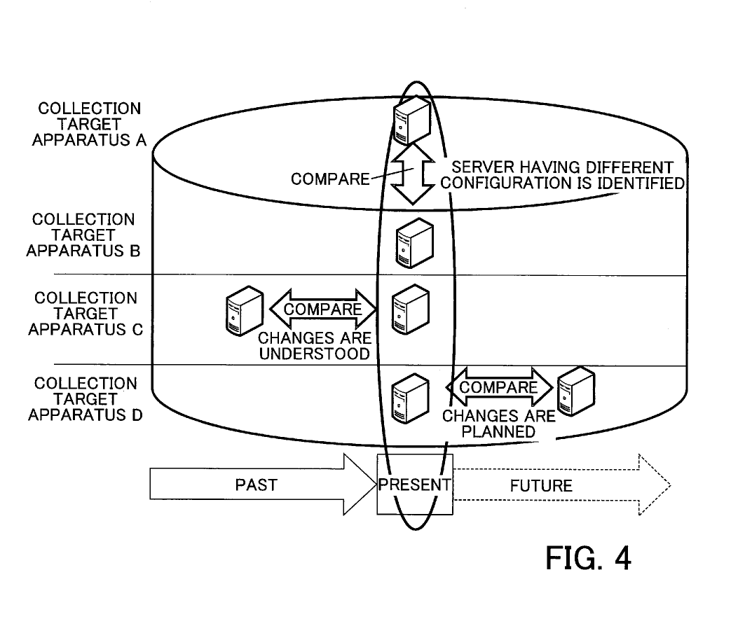

Next described is an example illustrating applications of configuration information. FIG. 4 illustrates an example of applications of configuration information. According to the example of FIG. 4, configuration information is collected from each of four collection target apparatuses. There are, for example, three situations in which configuration information is utilized, as described below.

The first example is concerned with comparing the latest configuration information of a plurality of collection target apparatuses to thereby identify collection target apparatuses having different configurations. According to the example of FIG. 4, the latest configuration information of a collection target apparatus A is compared to that of a collection target apparatus B.

The second example is concerned with comparing configuration information of the past with current configuration information to thereby understand changes in the configuration. According to the example of FIG. 4, past configuration information of a collection target apparatus C is kept and, then, compared with current configuration information.

The third example is concerned with planning (designing) of a system configuration of the future, and configuration information indicating a future target configuration of an apparatus is compared to current configuration information. This allows comprehension of apparatus configuration changes for achieving a desired system. According to the example of FIG. 4, future target configuration information of a collection target apparatus D is compared to current configuration information thereof.

In order to enable such configuration information applications, configuration information is collected by a management apparatus from each apparatus in the system and then stored. In many situations where configuration information is utilized, current configuration information of each collection target apparatus is desired. Therefore, it is important to ensure collection of the latest configuration information.

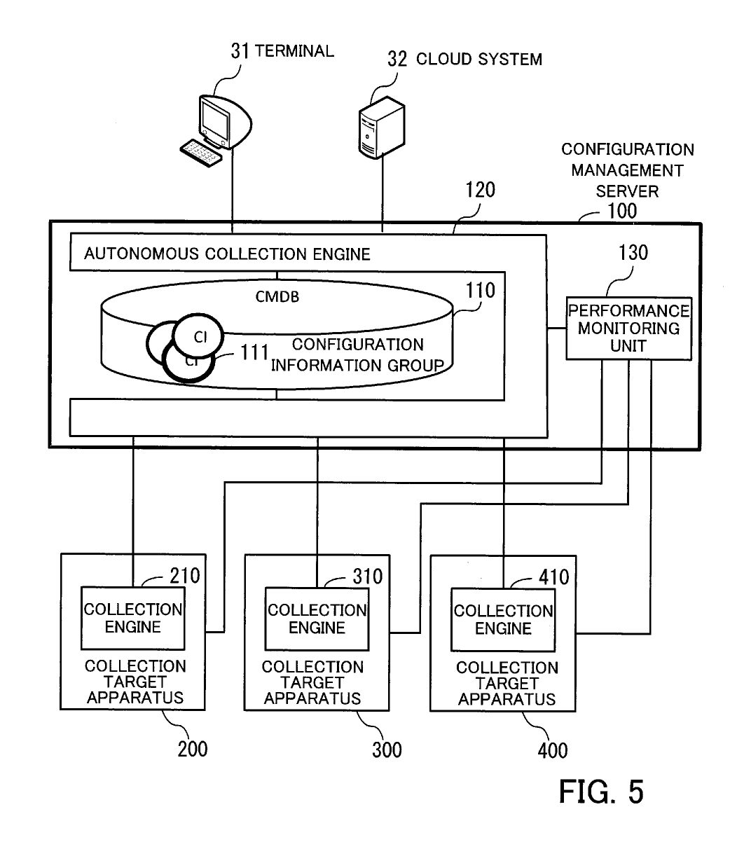

FIG. 5 is a block diagram illustrating functions of collecting configuration information. The configuration management server 100 includes a configuration management database (CMDB) 110, an autonomous collection engine 120, and a performance monitoring unit 130. The CMDB 110 is a database for storing a configuration information group 111. Configuration information is also referred to as “configuration item (CI)”. Through cooperation with the collection target apparatuses 200, 300, and 400, the autonomous collection engine 120 collects configuration information from each of the collection target apparatuses 200, 300, and 400. The autonomous collection engine 120 stores the collected configuration information in the CMDB 110 as the configuration information group 111. Note that the autonomous collection engine 120 acquires performance information of the collection target apparatuses 200, 300, and 400 from the performance monitoring unit 130 in order to determine a timing of collecting each configuration information item.

The performance monitoring unit 130 monitors the performance of the collection target apparatuses 200, 300, and 400. For example, the performance monitoring unit 130 acquires performance information from each of the collection target apparatuses 200, 300, and 400. The performance information is, for example, the current CPU utilization or a history of CPU utilization. The performance monitoring unit 130 transmits, to the autonomous collection engine 120, the acquired performance information or statistics obtained by analyzing the performance information.

The collection target apparatuses 200, 300, and 400 include collection engines 210, 310, 410, respectively. Each of the collection engines 210, 310, and 410 collects configuration information of its own apparatus, and transmits the configuration information to the configuration management server 100.

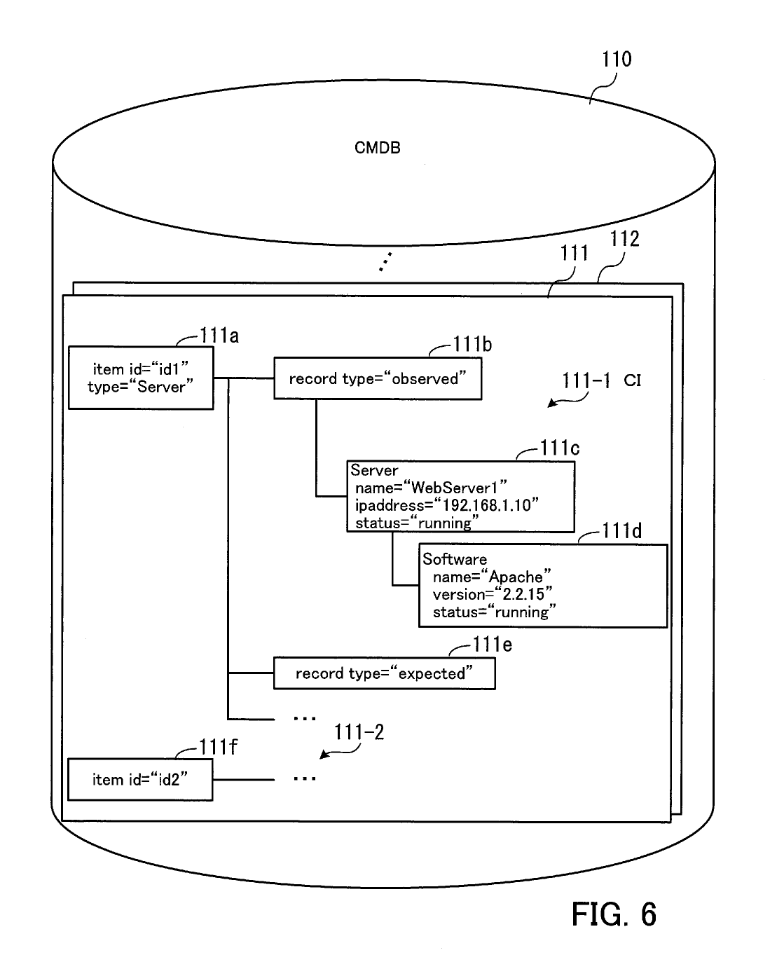

FIG. 6 illustrates an example of a CMDB. The CMDB 110 stores therein configuration information groups 111, 112, and so on each associated with a different ICT system. The configuration information group 111 in the CMDB 110 includes a plurality of configuration information items (CI: configuration items) 111-1, 111-2, and so on. Note here that one configuration information item corresponds to one item. Each item includes a plurality of records. Under each record, configuration information items of a server, a network, and the like in forms are stored.

For example, as for the configuration information item 111-1, elements 111b, 111e, and so on indicating records are set under an element 111a in which an identifier and a type of an item are set. Under the element 111b indicating a record, a plurality of elements 111c and 111d are set in a hierarchical structure. The first line in each of the elements 111c and 111d is an element name. For example, the element name of the element 111c is “Server”. A character string in each line below the element name of each element denotes one attribute. For example, ipaddress=“192.168.1.10” in the element 111c is one attribute, and “192.168.1.10” is a value of the attribute.

Next described are discovery methods for collecting configuration information items. The discovery methods include periodic discovery, acquisition-type discovery, and notification-type discovery.

<Periodic Discovery>

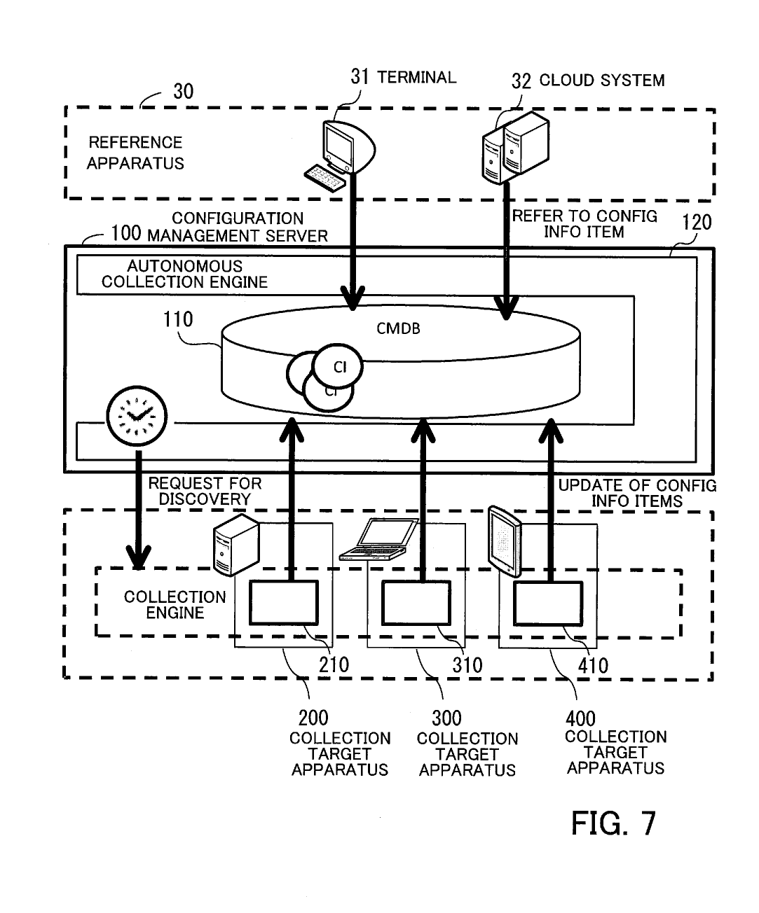

The periodic discovery is described first. FIG. 7 illustrates an example of a periodic discovery process. The periodic discovery is a method for executing a discovery process at a predetermined time according to a schedule. The periodic discovery is carried out in the following procedure.

[Step 1] Discovery Request

The autonomous collection engine 120 of the configuration management server 100 transmits a discovery request to each of the collection target apparatuses 200, 300, and 400 at the time specified in the schedule.

[Step 2] Update of Configuration Information Items

Each of the collection engines 210, 310, and 410 of the individual collection target apparatuses 200, 300, and 400, respectively, collects configuration information items from its own apparatus. Then, each of the collection engines 210, 310, and 410 transmits the collected configuration information items to the configuration management server 100. In the configuration management server 100, the autonomous collection engine 120 receives the configuration information items and registers the received configuration information items in the CMDB 110.

[Step 3] Reference to Configuration Information Item

Using a reference apparatus 30 (the terminal 31 or the cloud system 32), a user accesses the CMDB 110 of the configuration management server 100 and refers to a configuration information item collected by the periodic discovery.

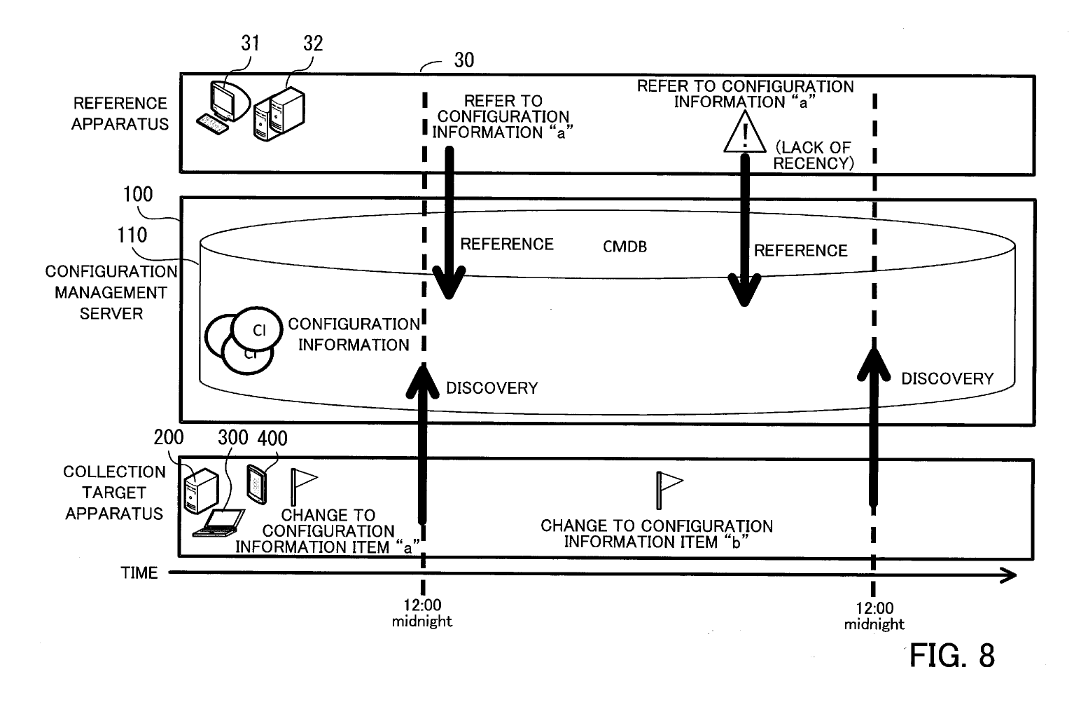

FIG. 8 illustrates a practical example of the periodic discovery. According to the example of FIG. 8, a discovery process is scheduled to be carried out at midnight every day. In this case, the configuration management server 100 collects configuration information items of the individual collection target apparatuses 200, 300, and 400 at midnight every day, and then corresponding configuration information items in the CMDB 110 are updated.

Because acquiring configuration information items at once, such a periodic discovery process puts load on the collection target apparatuses 200, 300, and 400 and the configuration management server 100 during the execution. However, it is possible not to affect the operation of the system by scheduling the discovery process to take place during the time when the system is not running (for example, midnight every day).

Under this situation, assume that the value of one of the configuration information items of the collection target apparatuses 200, 300, and 400 changes to “a”. The change is reflected in the CMDB 110 when a discovery process is carried out at midnight on the day. When turning to the configuration information item on the following day, the reference apparatus 30 is able to refer to the configuration information item with the value “a” changed the previous day. Subsequently, assume that the value of the configuration information item of the collection target apparatuses 200, 300, and 400 changes to “b”. When turning to the configuration information item on the same day, the reference apparatus 30 still refers to the configuration information item with the value “a”. That is, although the value of the configuration information item has changed to “b”, the reference apparatus 30 is able to refer to not “b” but “a”, and thus the configuration information item lacks recency. As seen above, although the periodic discovery has no adverse effect on the operation of the system, it does not support the use of the latest configuration information.

<Acquisition-Type Discovery>

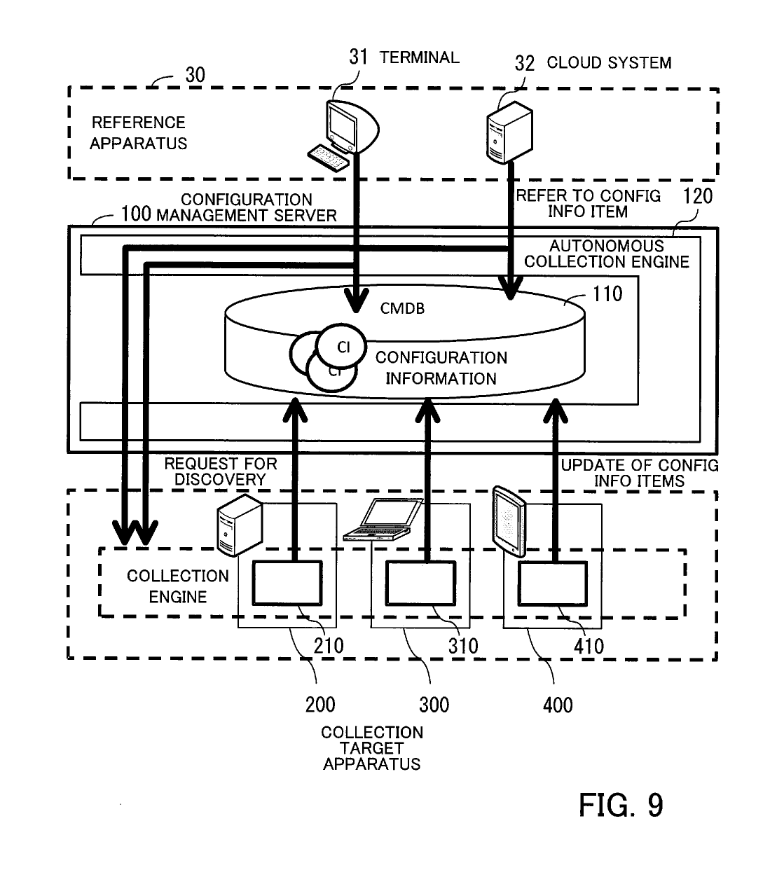

Next described is the acquisition-type discovery. FIG. 9 illustrates an example of an acquisition-type discovery process. The acquisition-type discovery is a method for acquiring configuration information items when reference is made to a configuration information item. The acquisition-type discovery is carried out in the following procedure.

[Step 1] Reference Request

A request for referring to a configuration information item is transmitted from the reference apparatus 30 to the configuration management server 100. For example, the terminal 31 transmits a reference request according to an input of the user. In addition, the cloud system 32 transmits a reference request when a process of using a configuration information item has occurred as part of service delivery.

[Step 2] Discovery Request

The autonomous collection engine 120 of the configuration management server 100 transmits a discovery request to each of the collection target apparatus 200, 300, and 400.

[Step 3] Update of Configuration Information Item

Each of the collection engines 210, 310, and 410 of the individual collection target apparatuses 200, 300, and 400, respectively, collects configuration information items from its own apparatus. Then, each of the collection engines 210, 310, and 410 transmits the collected configuration information items to the configuration management server 100. In the configuration management server 100, the autonomous collection engine 120 receives the configuration information items and registers the received configuration information items in the CMDB 110.

[Step 4] Reference to Configuration Information Item

The autonomous collection engine 120 transmits a received configuration information item to the reference apparatus 30 which has transmitted the reference request. This enables the configuration information item to be referred to on the reference apparatus 30.

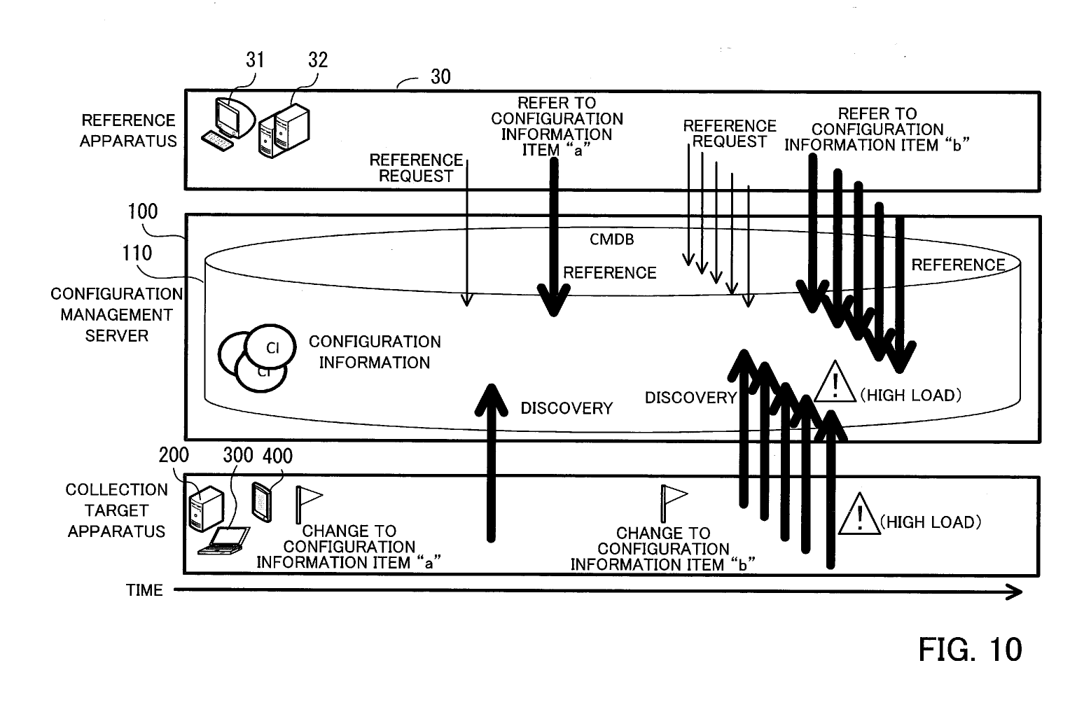

FIG. 10 illustrates a practical example of the acquisition-type discovery. Assume here that the value of one of the configuration information items of the collection target apparatuses 200, 300, and 400 changes to “a”. In the case of the acquisition-type discovery, a discovery process is carried out subsequently when a reference request is transmitted from the reference apparatus 30. The reference apparatus 30 refers to the configuration information item in the CMDB 110 after the completion of the discovery process. In this manner, the configuration information with the updated value “a” is referred to on the reference apparatus 30.

Similarly, subsequently after the value of the configuration information item of the collection target apparatuses 200, 300, and 400 changes to “b”, a discovery process is carried out each time a reference request is issued. Therefore, the reference apparatus 30 is able to refer to the configuration information item with the updated value “b”.

The acquisition-type discovery supports the use of the latest configuration information items; however, in the case where a plurality of reference requests take place at the same time, not only the collection target apparatuses 200, 300, and 400 but also the configuration management server 100 is placed under substantial load, which has an adverse effect on the operation of the system. In addition, according to the acquisition-type discovery, a discovery process is uniformly carried out also for configuration information items with no changes at the time of reference, which places unnecessary load on the collection target apparatuses 200, 300, and 400 and the configuration management server 100.

<Notification-Type Discovery>

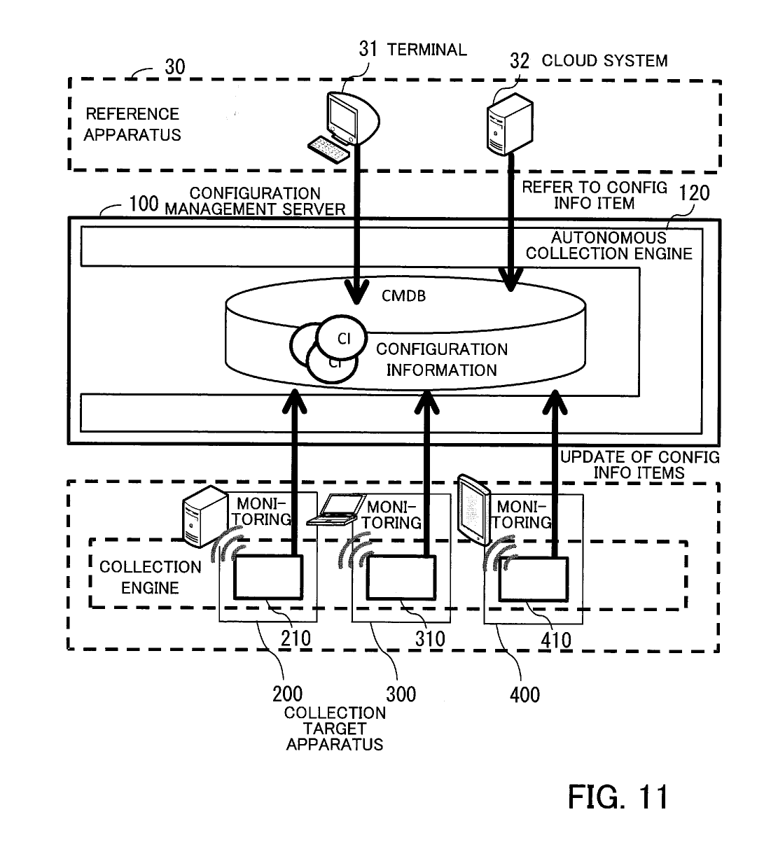

Next described is the notification-type discovery. FIG. 11 illustrates an example of a notification-type discovery process. The notification-type discovery is a method for acquiring configuration information items when a change is made to a configuration information item. The notification-type discovery is carried out in the following procedure.

[Step 1] Monitoring

Each of the collection engines 210, 310, and 410 of the collection target apparatuses 200, 300, and 400, respectively, monitors a change in configuration information items of its collection target apparatus.

[Step 2] Update of Configuration Information Item

When a change is made to a configuration information item, the collection engines 210, 310, and 410 acquire the changed configuration information item and transmit it to the configuration management server 100. The autonomous collection engine 120 of the configuration management server 100 stores, in the CMDB 110, the configuration information item transmitted from the collection target apparatuses 200, 300, and 400.

[Step 3] Reference to Configuration Information Item

A reference request is transmitted from the reference apparatus 30 to the configuration management server 100. The configuration management server 100 accesses the CMDB 110 and returns, to the reference apparatus 30, the latest configuration information item having been updated in response to the change. This enables the configuration information item to be referred to on the reference apparatus 30.

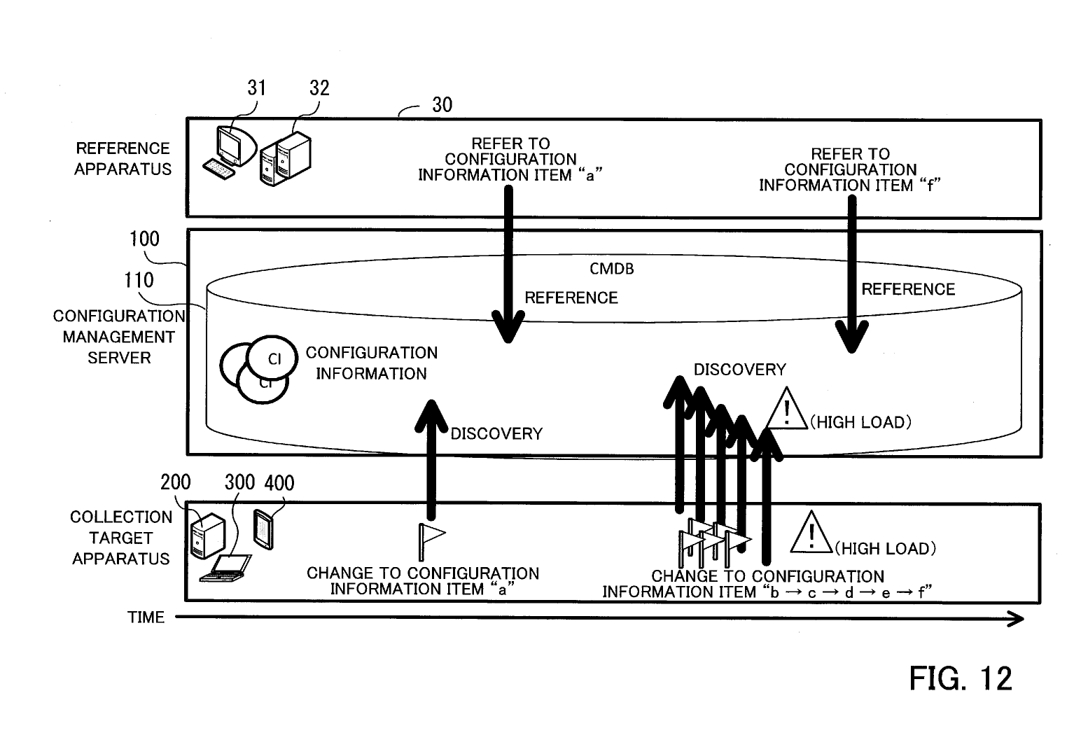

FIG. 12 illustrates a practical example of the notification-type discovery. As for the notification-type discovery, a discovery process takes place when the value of one of configuration information items of the collection target apparatuses 200, 300, and 400 has changed to “a”. The reference apparatus 30 refers to the configuration information item in the CMDB 110 after the completion of the discovery process. In this manner, the configuration information with the updated value “a” is referred to on the reference apparatus 30.

Subsequently, similarly when the value of the configuration information item of the collection target apparatuses 200, 300, and 400 changes to “b”, “c”, “d”, “e”, and “f” any number of times, the discovery process takes place each time a change is made to the configuration information item. Then, the reference apparatus 30 is able to refer to the configuration information item with the value “f” updated the last time.

The notification-type discovery supports the use of the latest configuration information; however, in the case where repeated changes are made to a configuration information item over a short period of time, it puts substantial load on not only the corresponding collection target apparatus but also the configuration management server 100, which has an adverse effect on the operation of the system. In addition, the notification-type discovery monitors changes in configuration information items of the collection target apparatuses 200, 300, and 400 at all times, thus continuously putting constant load on the collection target apparatuses 200, 300, and 400.

Amongst the three discovery methods, the periodic discovery is effective if recency of configuration information is not called for. For example, one possible application is to do maintenance on the system using the periodic discovery during nighttime hours when the periodic discovery has no impact on the system operation and determine the following morning changes in the configuration information involved in the system maintenance. However, due to the arrival of cloud technology, ensuring recency of configuration information has become important as never before. Because the periodic discovery is not able to ensure recency of configuration information, it is not appropriate to operate a system utilizing the latest configuration information by the periodic discovery only. This basically comes down to adopting either the acquisition-type discovery or the notification-type discovery.

Which one of the acquisition-type discovery and the notification-type discovery is appropriate depends on the operational condition of the system. For example, with the advent of cloud computing technology, the application of using virtual servers by dynamically deploying additional or cancelling unneeded virtual servers has been popularly employed, contributing to shortening update cycles of the system configuration. Therefore, configuration information is also changed frequently. Furthermore, system configuration techniques are advancing from the manner of operation where a system administrator manually changes the system configuration to that where operations management software autonomously determines an optimum system configuration and makes a change to it. Because the system configuration is autonomously variable, the frequency of changing the configuration has increased.

In the case where the configuration information is changed frequently, if a discovery process is carries out each time a change is made to a configuration information item, as in the case of the notification-type discovery, there is an increased frequency of discovery processes, putting excessive load on the system. In view of this point only, the acquisition-type discovery would be effective. However, some configuration information items, like Internet Protocol (IP) addresses, hardly undergo changes during the operation. Carrying out a discovery process each time a user uses such a configuration information item with infrequent changes, as in the case of the acquisition-type discovery, leads to an increased number of useless discovery processes, thereby putting load on the collection target apparatuses 200, 300, and 400 and the configuration management server 100, which in turn has an adverse effect on the system operation.

In the case where simply a single discovery method is thus applied to all the configuration information items over the entire period of time, it is difficult to reduce the load placed on the collection target apparatuses 200, 300, and 400 and the configuration management server 100 while maintaining the recency of the configuration information items. Further, the advent of cloud technology and diversification of collection targets have brought about the diversification of configuration information desired by users. In addition, the manner of operation changes in the future from one where human changes the system configuration to one where operations management software autonomously determines an optimum system configuration and makes a change to it, which leads to no regular patterns in changes and usage of configuration information being observed. In view of this, the second embodiment is directed to a technique for offering great flexibility in the discovery processing timing by enabling a specific discovery method to be applied for each configuration information item and also allowing the discovery method to be dynamically changed according to the operational condition of the system.

One possible index used to determine an appropriate discovery method is, for example, the update frequency of each configuration information item (change attribute). The update frequency is the frequency at which a change is made to the configuration information item. Thus, each configuration information item has attributes related to the update frequency. For example, information such as the resource utilization and performance always changes while information such as an IP address and a host name of a terminal changes only when a change is made to the operation. Further, information items regarding a serial number and a media access control (MAC) address associated with a chassis of a server are not changed in principle.

If the notification-type discovery is adopted for configuration information items with high update frequencies (change attribute), the configuration information items are frequently discovered, putting substantial load on not only the collection target apparatuses 200, 300, and 400 but also the configuration management server 100, which in turn has an adverse effect on the operation of the system. Therefore, the acquisition-type discovery is suitable for configuration information items with high update frequencies.

Adopting the acquisition-type discovery for configuration information items with low update frequencies (change attribute) leads to inefficient performance because the configuration information items are likely to undergo discovery processes in spite of being not updated. Further, even if the configuration information items have not been updated, the collection target apparatuses 200, 300, and 400 need to monitor whether the configuration information items have been updated, thus being placed under extra load. Therefore, the notification-type discovery is suitable for configuration information items with low update frequencies.

As a result, it is appropriate to adopt the acquisition-type discovery for configuration information items with high update frequencies and adopt the notification-type discovery for configuration information items with low update frequencies. Such determination of a discovery method is made for each configuration information item and the discovery method is dynamically changed according to the situation. This varies the discovery timing of each configuration information item, thus temporarily distributing the load on the collection target apparatuses 200, 300, and 400 and the configuration management server 100. That is, it is possible to prevent the load attributable to discovery processes from concentrating over a short period of time.

Thus, it is possible to distribute the load on the collection targets and the configuration management server 100 by automated determination of a discovery method based on the update frequency of each configuration information item and discover the latest configuration information item. However, in the operation of a common system, configuration information items with low update frequencies exist in large numbers. This results in a high proportion of configuration information items for which the notification-type discovery is adopted, putting load associated with monitoring configuration information items on the collection target apparatuses 200, 300, and 400, which in turn has an adverse effect on the operation of the system.

In view of the above, it may be reasonable to consider adopting, when the collection target apparatuses 200, 300, and 400 are placed under high load, not the notification-type discovery but the acquisition-type discovery for some of configuration information items with low update frequencies. For example, in the case where the collection target apparatuses 200, 300, and 400 are placed under high load, the acquisition-type discovery may be adopted for, amongst configuration information items with low update frequencies, those also with low reference frequencies. Adopting the acquisition-type discovery for configuration information items with low update and reference frequencies minimizes the degree of inefficiency resulted from carrying out discovery processes on non-updated configuration information items.

<Intelligent Discovery>

Apart from the problem of load on the system, the acquisition-type discovery has the problem of possibility that the condition where configuration information items of the collection target apparatuses 200, 300, and 400 do not match those stored in the CMDB 110 would remain for an extended period of time. That is, even if configuration information items not referred to for a long time are updated in the collection target apparatuses 200, 300, and 400, the acquisition-type discovery fails to reflect the update results in the CMDB 110. Leaving large amounts of configuration information whose changed values are not reflected in the CMDB 110 leads to a decrease in the reliability of the contents of the CMDB 110. Therefore, the configuration management server 100 periodically conducts an examination to see whether the configuration information of the CMDB 110 matches the reality.

In view of the above, according to the second embodiment, when the collection target apparatuses 200, 300, and 400 are placed under high load, both the acquisition-type discovery and the periodic discovery are applied in conjunction with each other to configuration information items with low update and reference frequencies. Note here that the discovery method of applying the acquisition-type discovery and the periodic discovery in conjunction with each other is referred to as the “intelligent discovery”.

In the intelligent discovery, the periodic discovery is carried out according to a fixed schedule (for example, at midnight every day), and the acquisition-type discovery is carried out when a configuration information item is referred to, to thereby ensure recency of the configuration information item. The schedule of the periodic discovery is set, for example, by the system administrator.

Note that, when the notification-type discovery is applied, the configuration information of the CMDB 110 always matches the reality, and therefore, there is no need to use the periodic discovery in conjunction with the notification-type discovery. Even in the case where the acquisition-type discovery is applied, if the reference frequency of each configuration information item is high, a period of time where the configuration information of the CMDB 110 does not reflect the reality is short. In such a case, the periodic discovery need not to be used in conjunction with the acquisition-type discovery.

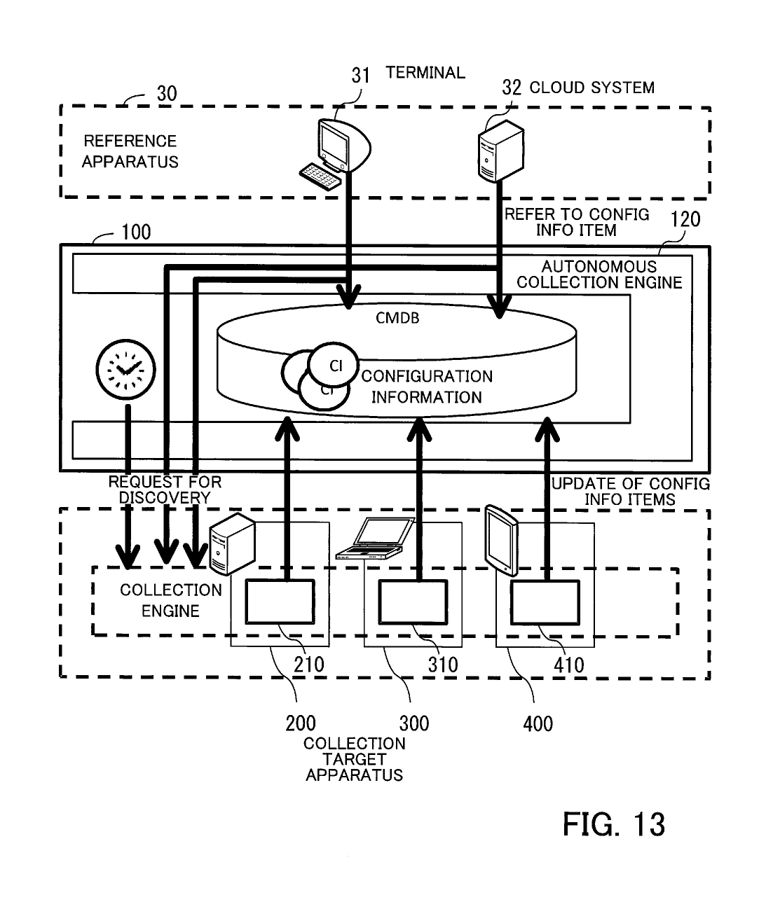

FIG. 13 illustrates an example of an intelligent discovery process. The intelligent discovery is a method for executing a discovery process in response to a reference to each configuration information item and in response to a determination by a scheduler that it is time to discover the configuration information item. These individual timings are determined in parallel. The processing procedure performed in response to a reference to a configuration information item is the same as that of the acquisition-type discovery. The processing procedure performed in response to a determination by the scheduler is the same as that of the periodic discovery.

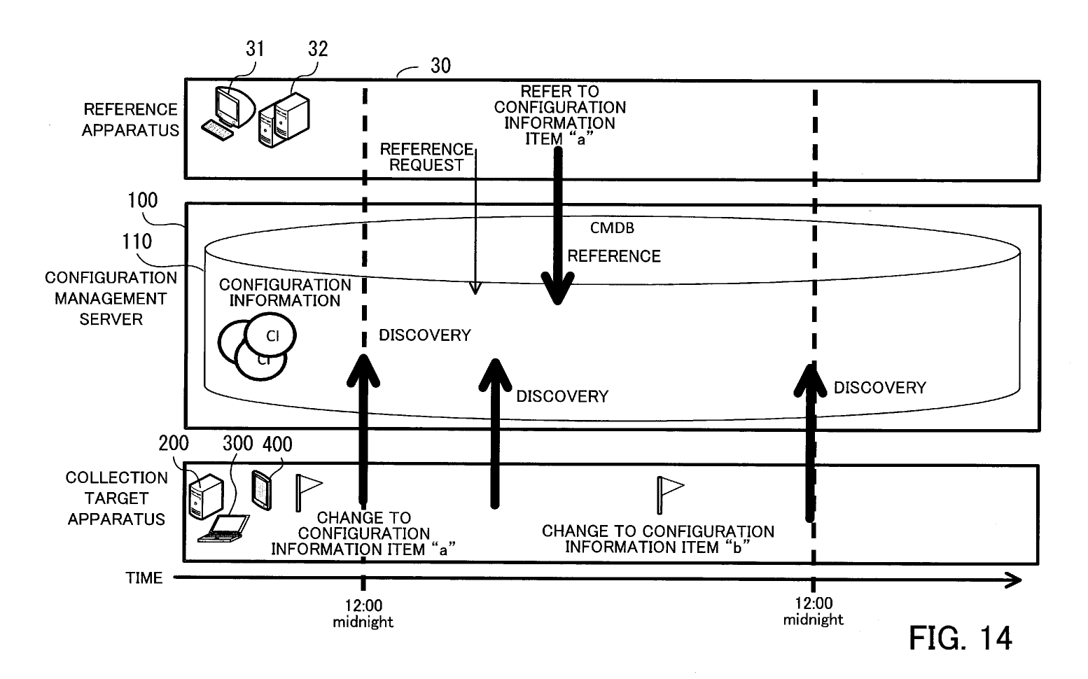

FIG. 14 illustrates a practical example of the intelligent discovery. According to the example of FIG. 14, a discovery process is scheduled by the scheduler to be carried out at midnight every day. Therefore, after the value of one of configuration information items of the collection target apparatuses 200, 300, and 400 has changed to “a”, a discovery process takes place at midnight and thereby the change is reflected in the CMDB 110. Subsequently also when a reference request is transmitted from the reference apparatus 30, a discovery process is carried out. The reference apparatus 30 refers to the configuration information item in the CMDB 110 after the completion of the discovery process. In this manner, the configuration information with the updated value “a” is referred to on the reference apparatus 30. Similarly, subsequently when the value of the configuration information item changes to “b”, a discovery process takes place at midnight without waiting for a reference request and thereby the change is reflected in the CMDB 110.

In the above described manner, the intelligent discovery ensures recency of configuration information and also periodically reflects an update of each configuration information item in the CMDB 110 even if no reference is made to the configuration information item. That is, in the case where the acquisition-type discovery alone is adopted for a configuration information item, no change is made to the configuration information item in the CMDB 110 even when a change has been made to the actual corresponding configuration if the configuration information item is not used. On the other hand, the intelligent discovery allows periodic updates of a configuration information item even when the configuration information item is not used.

Note however that even if the intelligent discovery is adopted, if a plurality of reference requests take place at the same time, the collection target apparatuses 200, 300, and 400 and the configuration management server 100 are placed under extra load, as in the case of adopting the acquisition-type discovery alone.

<Technique for Automated Determination of Discovery Method>

Next described is a technique for automatically determining a discovery method suitable for each configuration information item amongst the notification-type discovery, the acquisition-type discovery, and the intelligent discovery. The second embodiment uses, as indexes for determining a discovery method, the reference frequency (usage attribute) and the load on the collection target apparatus 200/300/400 in addition to the update frequency (change attribute).

The reference frequency is the frequency at which users refer to a configuration information item. Each configuration information item has a characteristic in its reference frequency. For example, the reference frequencies of information items such as the resource utilization and performance are high because their changes in a short span of time are desired to be monitored. As for information items such as application situations of patches and installed software, since periodic use is desired, references are made at constant rates although their reference frequencies are not very high. Information items such as a serial number and a media access control (MAC) address associated with a chassis of a server have low usage frequencies.

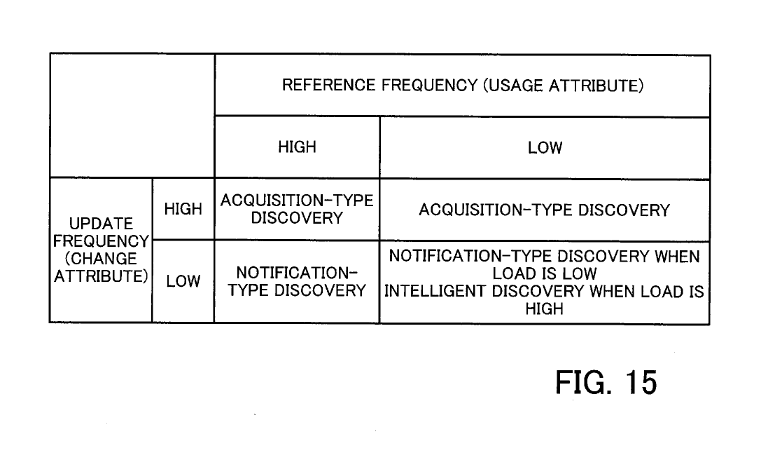

FIG. 15 illustrates an example of criteria for determining a discovery method. FIG. 15 represents discovery methods defined based on the update frequency and the reference frequency. The update frequency is determined, for example, to be “high” if the number of updates per hour is two or more, and determined to be “low” if the number of updates per hour is one or less. The reference frequency is determined, for example, to be “high” if the number of references per hour is two or more, and determined to be “low” if the number of references per hour is one or less.

With respect to a configuration information item with high update frequency, in order to obtain the latest configuration information item while reducing the load on the collection target and the configuration management server 100, it is preferable to carry out a discovery process when the configuration information item is used rather than each time a change is made to the configuration information item. In view of this, the acquisition-type discovery is adopted for each configuration information item with high update frequency regardless of its reference frequency and the load on the corresponding collection target apparatus 200/300/400.

Note that in the case of a configuration information item with both high update and reference frequencies, a discovery process is carried out with each reference; however, it is likely that the update frequency is higher than the reference frequency given automatic conversion of the configuration information item. In addition, adopting the acquisition-type discovery in this case leads to a reduction in the load associated with monitoring the configuration information item. Therefore, according to the second embodiment, the acquisition-type discovery is adopted for each configuration information item with both high update and reference frequencies.

With respect to a configuration information item with low update frequency, in order to obtain the latest configuration information item while reducing the load on the corresponding collection target apparatus 200/300/400 and the configuration management server 100, it is preferable to carry out a discovery process when a change is made to the configuration information item rather than when the configuration information item is used. In view of this, the notification-type discovery is in principle adopted for each configuration information item with low update frequency. Note however that when the corresponding collection target apparatus 200/300/400 is placed under high load and thus adopting the notification-type discovery is determined to have an impact on the operation of the system, the intelligent discovery is adopted in order to reduce the load on the collection target apparatus 200/300/400.

Note that in the case of a configuration information item with both low update and reference frequencies, adopting the acquisition-type discovery may seem reasonable when the corresponding collection target apparatus 200/300/400 is placed under low load. However, some configuration information items with low update frequencies, like IP addresses, are hardly updated during the system operation, and it is often the case that their update frequencies are lower than the corresponding reference frequencies. Therefore, for each configuration information item with both low update and reference frequencies, adopting the notification-style discovery results in a reduction in the number of discovery processes.

The configuration management server 100 dynamically determines a discovery method as illustrated in FIG. 15. That is, when the operational condition of the system has changed, changes are also made to the update and reference frequencies of configuration information items and the load on the collection target apparatuses 200, 300, and 400. According to such changes to the condition, appropriate discovery methods are automatically determined and old discovery methods are changed to the newly determined discovery methods.

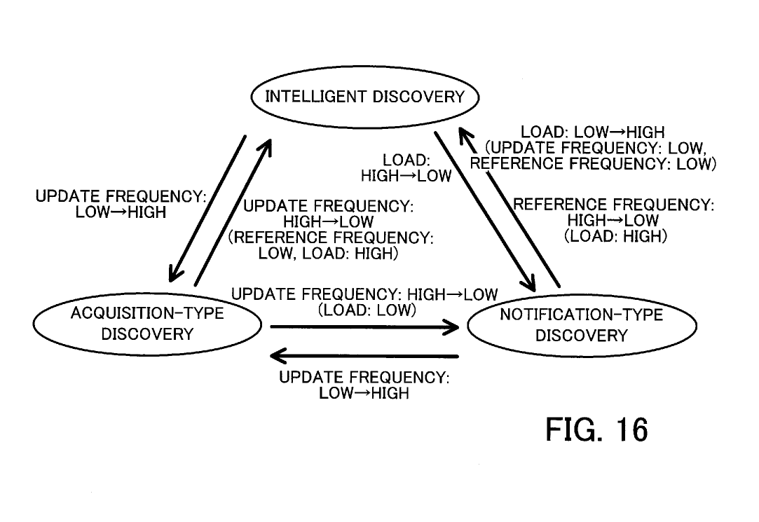

FIG. 16 illustrates an example of transitions of a discovery method according to changes in the operational condition. As for each configuration information item for which the intelligent discovery has been adopted, the discovery method is changed to the acquisition-type discovery when the update frequency increases from low to high. In addition, the load on a collection target apparatus having the configuration information item has decreased from high to low, the discovery method changes to the notification-type discovery.

As for each configuration information item for which the acquisition-type discovery has been adopted, when the update frequency decreases from high to low, the discovery method is changed to the intelligent discovery if the reference frequency is low and the load is high. In addition, in the case where the load is low when the update frequency decreases from high to low, the discovery method is changed to the notification-type discovery regardless of the level of the reference frequency.

As for each configuration information item for which the notification-type discovery has been adopted, when the load on a collection target apparatus having the configuration information item increases from low to high, the discovery method is changed to the intelligent discovery if both the update and reference frequencies are low. In addition, when the reference frequency decreases from high to low, the discovery method is changed to the intelligent discovery if the load is high. Further, when the update frequency increases from low to high, the discovery method is changed to the acquisition-type discovery.

<Performance Information>

Next described is performance information indicating the load on the collection target apparatus 200/300/400. As illustrated in FIG. 16, the load on a collection target apparatus is considered to determine a discovery method. For example, in the case where the load of the collection target apparatus is determined to have an impact on the operation of the system, the discovery method of some of configuration information items adopting the notification-type discovery is changed to the intelligent discovery.

The load on each collection target apparatus 200/300/400 is determined by the CPU utilization [%] of the collection target apparatus 200/300/400 acquired from the performance monitoring unit 130. In many system operations, a threshold for the performance (maximum CPU utilization [%]) is defined for each collection target apparatus 200/300/400, for example, in a Service Level Agreement (SLA). Therefore, in the case where the CPU utilization has exceeded, or is predicted to exceed, the threshold, the configuration management server 100 changes the discovery method of some of configuration information items adopting the notification-type discovery to the intelligent discovery.

[Prediction of Threshold Exceedance of CPU Utilization]

When the update frequency of each configuration information item adopting the acquisition-type discovery decreases from high to low, the configuration management server 100 determines whether the CPU utilization of a collection target apparatus having the configuration information item is likely to exceed a threshold. To that end, the configuration management server 100 calculates a monitoring load coefficient [%] for each collection target apparatus. The monitoring load coefficient is the increase rate of CPU utilization [%] when the number of configuration information items adopting the notification-type discovery is increased by one.

Calculating the monitoring load coefficient for each collection target apparatus allows an optimum discovery method tailored to the operation of the collection target apparatus to be automatically determined. The initial value of the monitoring load coefficient is set by the system administrator. The monitoring load coefficient per configuration information item is set, for example, to 0.01%. The monitoring load coefficient is automatically collected during the operation.

[Collection of Monitoring Load Coefficient]

The monitoring load coefficient is collected according to the degree of increase in the CPU utilization of a corresponding collection target apparatus at the time the discovery method of one or more configuration information items has been changed to the notification-type discovery. Assume here that the CPU utilization prior to the change to the notification-type discovery is 48%, and then, the discovery method of five configuration information items is changed to the notification-type discovery. The CPU utilization after the change is 49%. In this case, the monitoring load coefficient associated with monitoring of the collection target apparatus involved in the notification-type discovery is 0.2%. The calculation formula is as follows:

MLC=(U_{cpu} after change−U_{cpu} before change)/N,

where MLC is the monitoring load coefficient [%], U_{cpu} after change is the CPU utilization after the change of the discovery method [%], U_{cpu} before change is the CPU utilization before the change of the discovery method [%], and N is the number of configuration information items whose discovery method has been changed to the notification-type discovery [items]. Therefore, in the above case, MLC [%]=(49[%]−48[%])/5[items]=0.2[%].

Subsequently when the discovery method of configuration information items of the collection target apparatus is to be changed to the notification-type discovery, an increase in the CPU utilization [%] is calculated using the number of configuration information items whose discovery method is to be changed to the notification-type discovery [items] and the monitoring load coefficient [%]. Assume, for example, that the discovery method of ten configuration information items is to be changed to the notification-type discovery. In that case, an increase in the CPU utilization is calculated using the following formula:

U_{cpu+}=MLC×N_{c},

where U_{cpu+} is the increase in the CPU utilization [%], and N_{c} is the number of configuration information items whose discovery method is to be changed to the notification-type discovery [items]. Therefore in the above case, U_{cpu+}[%]=0.2 [%]×10 [items]=2 [%].

Assume here that the maximum CPU utilization of a collection target apparatus having the configuration information items whose discovery method is to be changed to the notification-type discovery is 50% and the current CPU utilization is 49%. In this case, changing the discovery method of the ten configuration information items to the notification-type discovery results in the CPU utilization of the collection target apparatus exceeding the maximum CPU utilization. The calculation formula is as follows:

New U_{cpu}=Current U_{cpu}+U_{cpu+},

where New U_{cpu} is the CPU utilization to be obtained after the change [%], and Current U_{cpu} is the current CPU utilization before the change [%]. Therefore in the above case, New U_{cpu}=49[%]+2[%]=51[%], which exceeds the maximum CPU utilization (50[%]).

Thus, the load on the collection target apparatus may exceed a predetermined value by changing the discovery method of configuration information items currently adopting the acquisition-type discovery to the notification-type discovery in response to reductions in the update frequencies of the configuration information items. In that case, the configuration management server 100 determines appropriate to change the discovery method of the configuration information items with reduced update frequencies to the intelligent discovery.

<Functions of Apparatuses to Implement Processing of Second Embodiment>

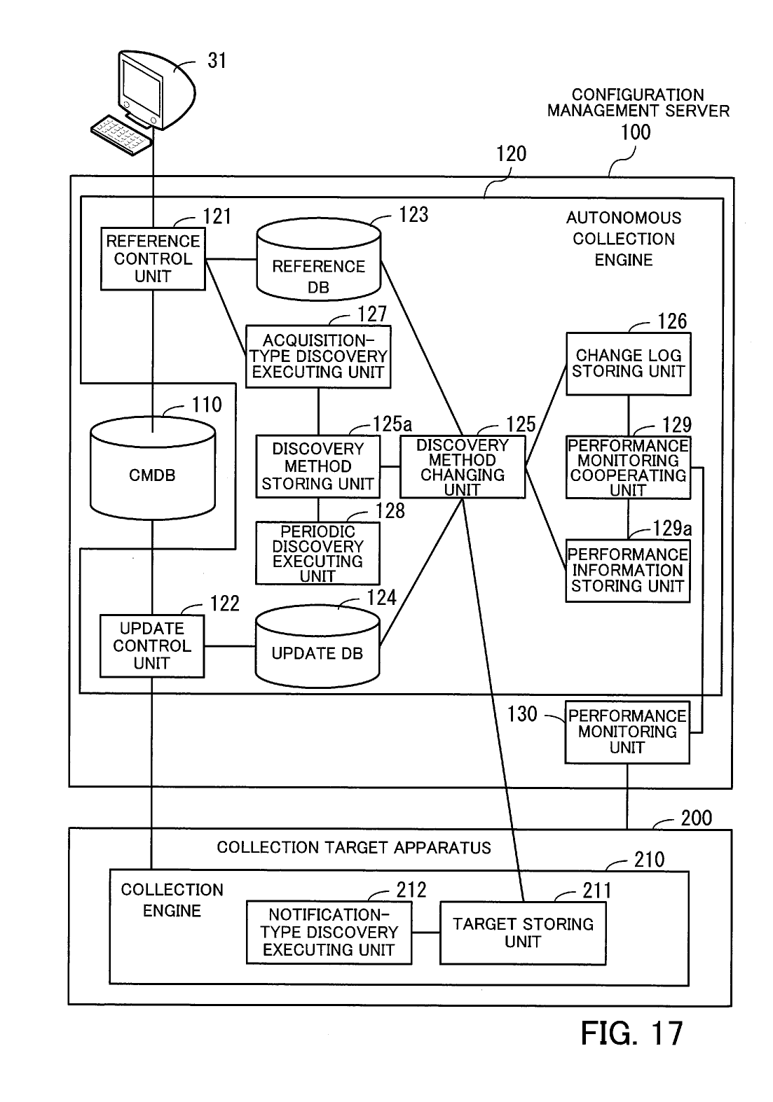

Next described are functions of individual apparatuses to implement processing of the second embodiment. FIG. 17 is a block diagram illustrating functions of individual apparatuses according to the second embodiment. The autonomous collection engine 120 of the configuration management server 100 includes a reference control unit 121, an update control unit 122, a reference database 123, an update database 124, a discovery method changing unit 125, a discovery method storing unit 125a, a discovery method change log storing unit 126, an acquisition-type discovery executing unit 127, a periodic discovery executing unit 128, a performance monitoring cooperating unit 129, and a performance information storing unit 129a.

The reference control unit 121 monitors the reference frequency of each configuration information item referred to by the reference apparatus 30. Then, the reference control unit 121 stores the reference frequency of each configuration information item in the reference database 123. In addition, in order to execute the acquisition-type discovery, the reference control unit 121 notifies the acquisition-type discovery executing unit 127 of the identifier of each referred-to configuration information item (for example, a set of the name of a corresponding collection target apparatus and the name of the referred-to configuration information item).

The update control unit 122 monitors the update frequency of each discovered configuration information item. Then, the update control unit 122 stores the update frequency of each configuration information item in the update database 124.

The reference database 123 stores therein information of reference frequencies. The content of the reference database 123 is registered or updated by the reference control unit 121. In addition, the reference database 123 is periodically referred to by the discovery method changing unit 125.

The update database 124 stores therein information of update frequencies. The content of the update database 124 is registered or updated by the update control unit 122. In addition, the update database 124 is periodically referred to by the discovery method changing unit 125.

The discovery method changing unit 125 automatically determines a discovery method for each configuration information item based on the update and reference frequencies of the configuration information item and the performance information of the corresponding collection target apparatus 200/300/400. For example, the discovery method changing unit 125 automatically determines a discovery method supporting both load reduction of the collection target apparatus 200/300/400 and the configuration management server 100 and the recency of the configuration information item and changes a discovery method to be applied to the determined one.

Specifically, the discovery method changing unit 125 periodically refers to the reference database 123, the update database 124, and the performance information storing unit 129a. Then, the discovery method changing unit 125 acquires the reference frequency and the update frequency from the reference database 123 and the update database 124, respectively, and acquires the load on the collection target apparatus (for example, the current CPU utilization and the monitoring load coefficient) from the performance information storing unit 129a. Note that the discovery method changing unit 125 is also able to delete the reference and update frequencies of a configuration information item having removed from the management targets from the reference database 123 and the update database 124, respectively.

The discovery method changing unit 125 determines a discovery method based on the acquired update frequency, reference frequency, and performance information, and sets the determined discovery method in the discovery method storing unit 125a. In addition, in the case where the determined discovery method of the configuration information item is the notification-type discovery, the discovery method changing unit 125 registers the configuration information item in the notification-type discovery target storing unit 211 of a corresponding collection target apparatus (for example, the collection target apparatus 200) having the configuration information item. By reflecting the determination result of the discovery method in the discovery method storing unit 125a and the notification-type discovery target storing unit 211, the discovery method of the configuration information item is changed. In addition, the discovery method changing unit 125 writes the change history of the discovery method in the discovery method change log storing unit 126.

The discovery method storing unit 125a stores therein the discovery method of each configuration information item associated with each collection target apparatus. The discovery methods stored in the discovery method storing unit 125a are registered, updated, and deleted by the discovery method changing unit 125. The discovery method storing unit 125a is referred to by the acquisition-type discovery executing unit 127 and the periodic discovery executing unit 128.

The discovery method change log storing unit 126 stores therein change histories of discovery methods. The discovery method changing unit 125 writes each change history of a discovery method in the discovery method change log storing unit 126. The change histories of discovery methods in the discovery method change log storing unit 126 are referred to by the performance monitoring cooperating unit 129.

The acquisition-type discovery executing unit 127 executes the acquisition-type discovery. For example, the acquisition-type discovery executing unit 127 acquires, from the reference control unit 121, a list of configuration information items targeted in reference requests received from the reference apparatus 30. Next, the acquisition-type discovery executing unit 127 identifies, amongst the list of configuration information items requested by the reference apparatus 30, configuration information items whose discovery method is set in the discovery method storing unit 125a as the acquisition-type discovery. Then, the acquisition-type discovery executing unit 127 executes the acquisition-type discovery on the identified configuration information items.

The periodic discovery executing unit 128 executes the periodic discovery. For example, the periodic discovery executing unit 128 periodically refers to the discovery method storing unit 125a. Then, the periodic discovery executing unit 128 identifies, amongst configuration information items in the discovery method storing unit 125a, those to which the intelligent discovery is applied, and executed the periodic discovery according to the schedule designated for each of the identified configuration information items.

The performance monitoring cooperating unit 129 cooperates with the performance monitoring unit 130 to manage the performance information of the collection target apparatuses 200, 300, and 400. For example, with reference to the discovery method change log storing unit 126, the performance monitoring cooperating unit 129 compiles data, for each of the collection target apparatuses 200, 300, and 400, on how many configuration information items there are whose discovery method has been changed to the notification-type discovery and when the changes took place. In addition, with respect to each of the collection target apparatuses 200, 300, and 400, the performance monitoring cooperating unit 129 acquires, from the performance monitoring unit 130, the maximum CPU utilization, the current CPU utilization, and the CPU utilization history. Then, the performance monitoring cooperating unit 129 calculates, for each of the collection target apparatuses 200, 300, and 400, the monitoring load coefficient based on the acquired discovery method change history (i.e., how many and when) and the acquired CPU utilization history.

Then, the performance monitoring cooperating unit 129 writes, in the performance information storing unit 129a, the maximum CPU utilization, the current CPU utilization, and the monitoring load coefficient of each of the collection target apparatuses 200, 300, and 400. Note that the performance monitoring cooperating unit 129 deletes, from the performance information storing unit 129a, the maximum CPU utilization, the current CPU utilization, and the monitoring load coefficient of a collection target apparatus having removed from the management targets.

The performance information storing unit 129a stores therein the maximum CPU utilization, the current CPU utilization, and the monitoring load coefficient of each collection target apparatus. The maximum CPU utilization, current CPU utilization, and monitoring load coefficients stored in the performance information storing units 129a are registered, updated, and deleted by the performance monitoring cooperating unit 129, and referred to by the discovery method changing unit 125.

The collection engine 210 of the collection target apparatus 200 includes a notification-type discovery target storing unit 211 and a notification-type discovery executing unit 212. The notification-type discovery target storing unit 211 stores therein, with respect to each collection target apparatus, a list of configuration information items subject to the notification-type discovery. The lists of configuration information items stored in the notification-type discovery target storing unit 211 are registered and deleted by the discovery method changing unit 125. In addition, the notification-type discovery target storing unit 211 is periodically referred to by the notification-type discovery executing unit 212.

The notification-type discovery executing unit 212 executes the notification-type discovery. For example, the notification-type discovery executing unit 212 periodically refers to the notification-type discovery target storing unit 211 to acquire a list of configuration information items subject to the notification-type discovery. Then, the notification-type discovery executing unit 212 monitors the presence or absence of a change in the values of configuration information items on the list. If there is a change in the configuration information item being monitored, the notification-type discovery executing unit 212 transmits the changed value of the configuration information item to the configuration management server 100.

In FIG. 17, each line connecting the individual components represents a part of communication paths, and communication paths other than those illustrated in FIG. 17 are also configurable. Further, the function of each component illustrated in FIG. 17 is implemented, for example, by causing a computer to execute a program module corresponding to the component.

Note that each or a combination of the functional elements illustrated in FIG. 17 is an example of a corresponding unit of the first embodiment of FIG. 1: the discovery method changing unit 125 is an example of the determining unit 12; the function obtained by combining the update control unit 122, the acquisition-type discovery executing unit 127, and the periodic discovery executing unit 128 is an example of the acquiring unit 13; the function obtained by combining the performance monitoring cooperating unit 129 and the performance monitoring unit 130 is an example of the load monitoring unit 14; the reference control unit 121 is an example of the reference managing unit 15; and the function obtained by combining the CMDB 110, the reference database 123, the update database 124, the discovery method change log storing unit 126, and the performance information storing unit 129a is an example of the storing unit 11.

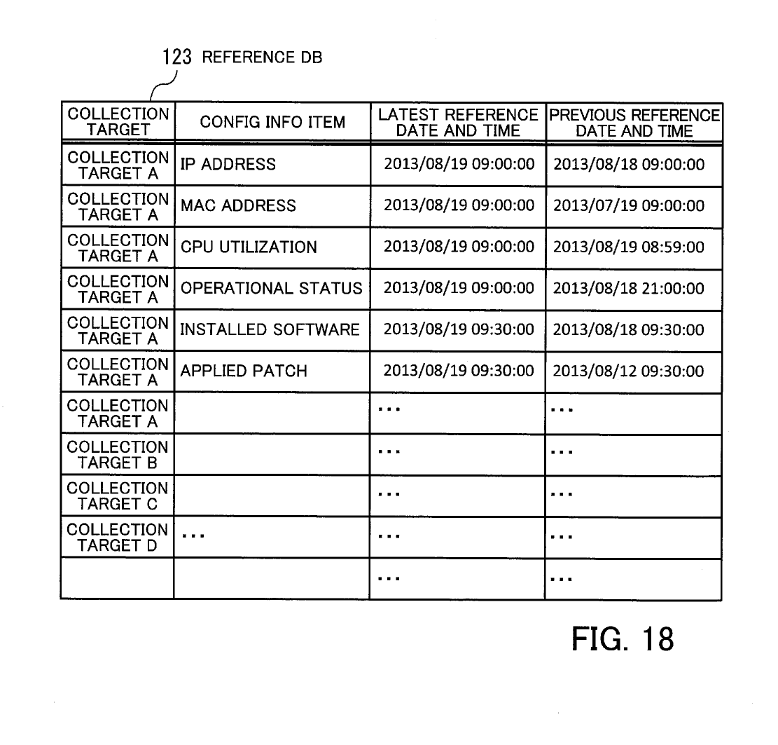

Various types of information content used to determine a discovery method is described next in detail. FIG. 18 illustrates an example of a data structure of a reference database. The reference database 123 includes the following information setting items for each record: collection target; configuration information item; latest reference date and time; and previous reference date and time. As illustrated in FIG. 18, in the collection target column, each entry contains the name of a collection target apparatus (collection target A, collection target B, or the like) having a corresponding referred-to configuration information item. In the configuration information item column, each entry contains the name of the referred-to configuration information item. In the latest reference date and time column, each entry contains the date and time of the latest reference to the corresponding configuration information item. In the previous reference date and time column, each entry contains the date and time of reference to the corresponding configuration information item preceding the latest reference.

The time between the previous and the latest reference date and time is a reference interval of the configuration information item. The reference interval indicates the reference frequency of the configuration information item. For example, the value obtained by dividing a unit of time by the reference interval is used as the reference frequency (the number of references per unit time).

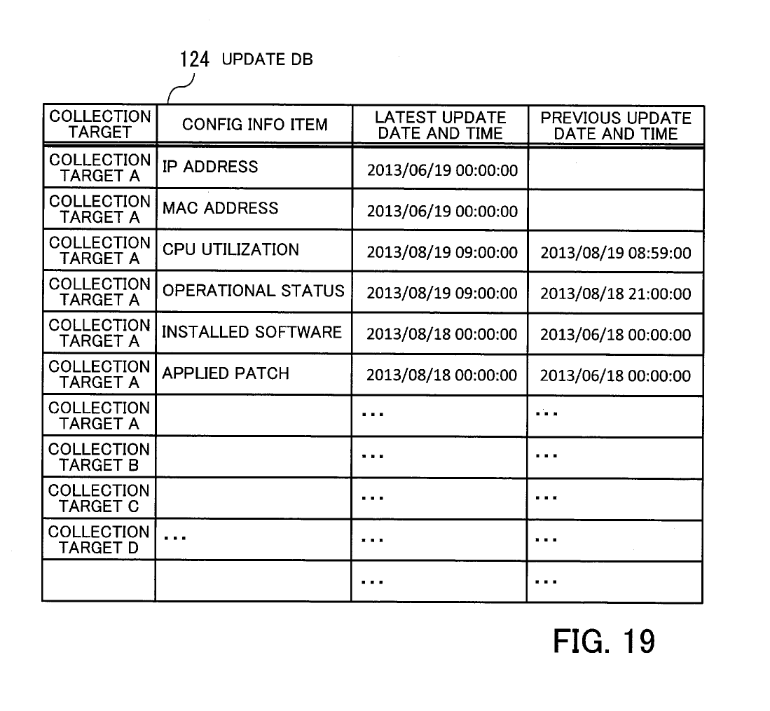

FIG. 19 is an example of a data structure of an update database. The update database 124 includes the following information setting items for each record: collection target; configuration information item; latest update date and time; and previous update date and time. As illustrated in FIG. 19, in the collection target column, each entry contains the name of a collection target apparatus having a corresponding updated configuration information item. In the configuration information item column, each entry contains the name of the updated configuration information item. In the latest update date and time column, each entry contains the date and time of the latest update to the corresponding configuration information item. In the previous update date and time column, each entry contains the date and time of an update to the corresponding configuration information item preceding the latest update. The time between the previous and the latest update date and time is an update interval of the configuration information item. The update interval indicates the update frequency of the configuration information item. For example, the value obtained by dividing a unit of time by the update interval is used as the update frequency (the number of updates per unit time).

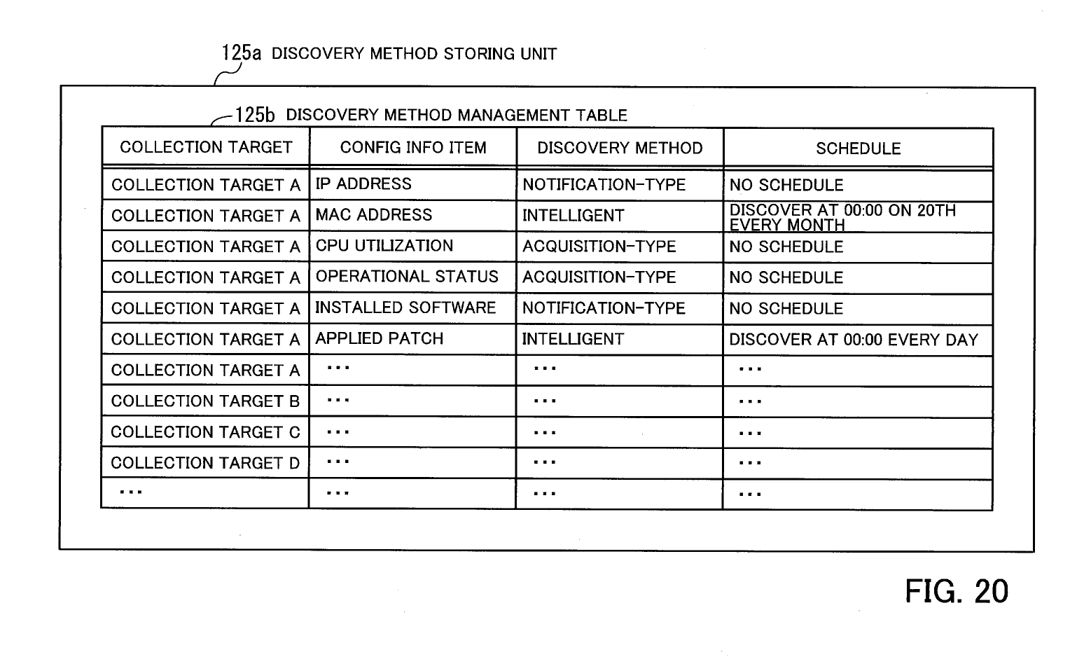

FIG. 20 illustrates an example of a data structure of a discovery method storing unit. The discovery method storing unit 125a includes a discovery method management table 125b. The discovery method management table 125b is used to set a discovery method for each configuration information item to be collected. The discovery method management table 125b includes columns of collection target, configuration information, discovery method, and schedule.

In the collection target column, each entry contains the name of a collection target apparatus having a corresponding configuration information item. In the configuration information item column, each entry contains the name of the configuration information item. In the discovery method column, each entry contains a discovery method to be applied to the corresponding configuration information item. In the schedule column, each entry contains a schedule of the periodic discovery if the intelligent discovery is adopted for the corresponding configuration information item as the discovery method.

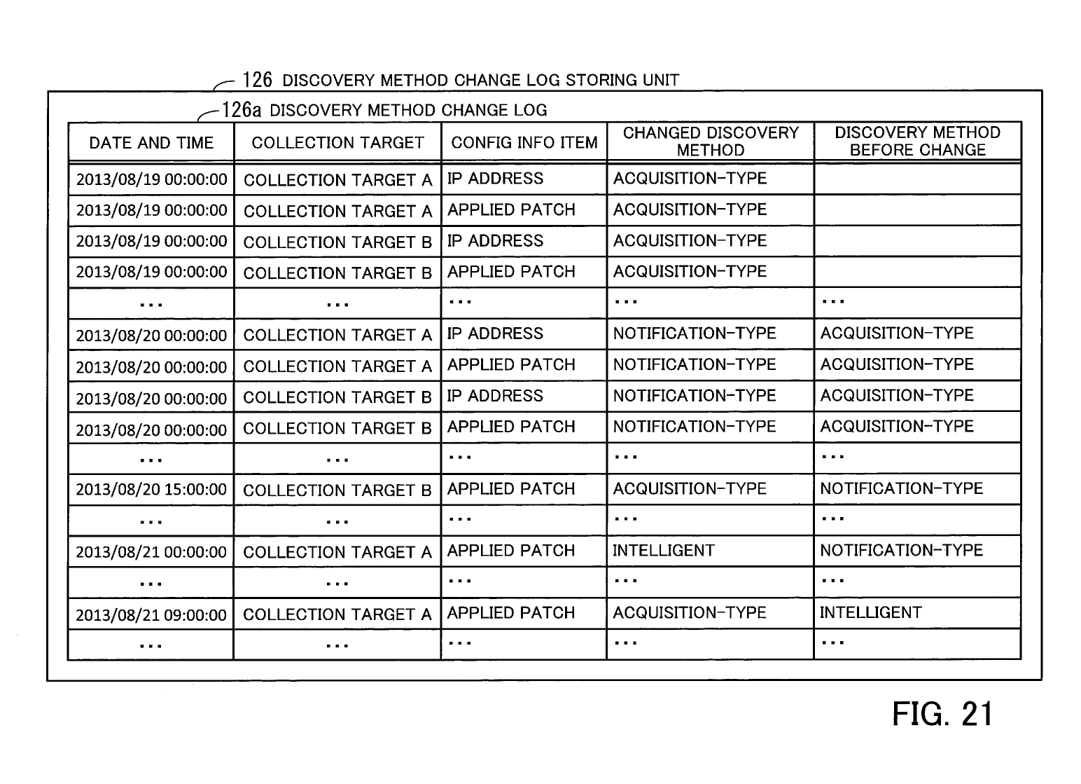

FIG. 21 is an example of a data structure of a discovery method change log storing unit. The discovery method change log storing unit 126 includes a discovery method change log 126a. The discovery method change log 126a is information indicating change content associated with a change in the discovery method for each configuration information item. The discovery method change log 126a includes columns of date and time, collection target, configuration information item, changed discovery method, and discovery method before change.

In the date and time column, each entry contains the date and time on which a discovery method of a corresponding configuration information item was changed. In the collection target column, each entry contains the name of a collection target apparatus having the corresponding configuration information item whose discovery method was changed. In the configuration information column, each entry contains the name of the configuration information item whose discovery method was changed. In the changed discovery method column, each entry contains the changed discovery method of the corresponding configuration information item. In the discovery method before change column, each entry contains the discovery method of the corresponding configuration information item before the change.

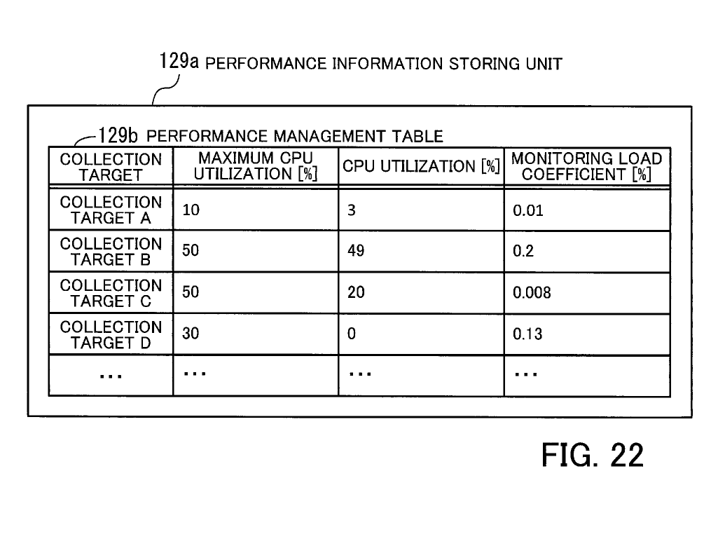

FIG. 22 illustrates an example of a data structure of a performance information storing unit. The performance information storing unit 129a stores therein a performance management table 129b for setting performance information of collection target apparatuses. The performance management table 129b includes columns of collection target, maximum CPU utilization, CPU utilization, and monitoring load coefficient. According to the example of FIG. 22, CPU utilization is employed as the performance information of each collection target apparatus.

In the collection target column, each entry contains the name of a collection target apparatus. In the maximum CPU utilization column, each entry contains the maximum CPU utilization [%] available for the corresponding collection target apparatus. In the CPU utilization column, each entry contains the current CPU utilization [%] of the corresponding collection target apparatus. In the monitoring load coefficient column, each entry contains the monitoring load coefficient [%] of the corresponding collection target apparatus.

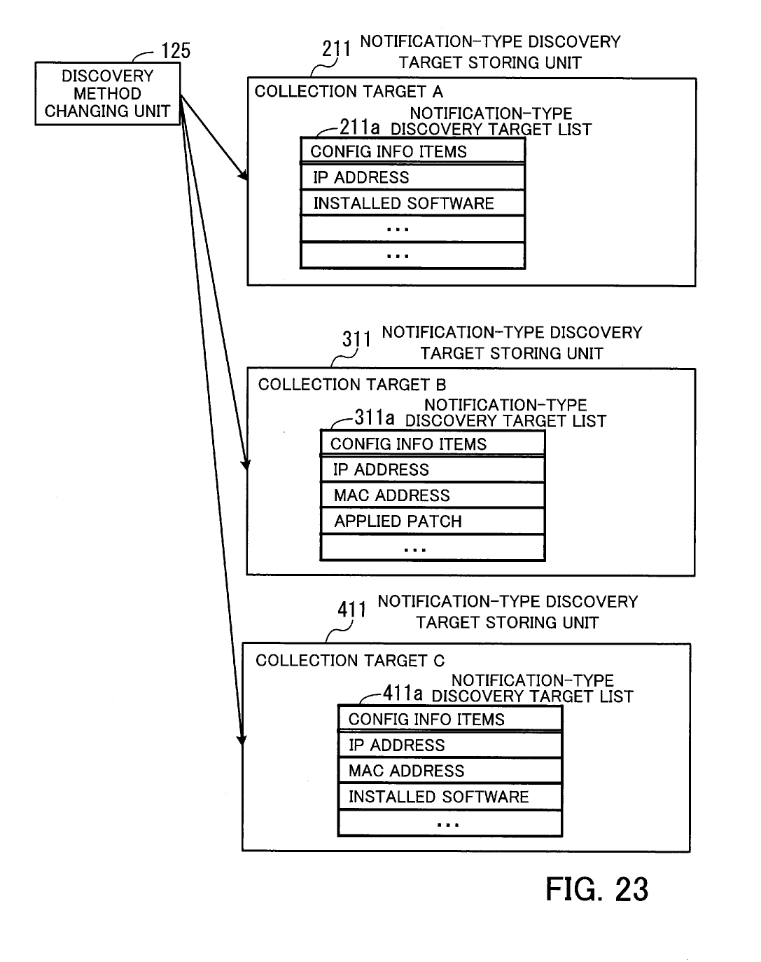

FIG. 23 illustrates an example of a data structure of a notification-type discovery target storing unit in each collection target apparatus. The collection target apparatuses 200, 300, and 400 include notification-type discovery target storing units 211, 311, and 411, respectively. Adding and deleting content to and from the notification-type discovery target storing unit 211, 311, and 411 are solely handled by the discovery method changing unit 125 of the configuration management server 100.

The notification-type discovery target storing units 211, 311, and 411 store therein, for example, notification-type discovery target lists 211a, 311a, and 411a, respectively. Each of the notification-type discovery target lists 211a, 311a, and 411a is a list of configuration information items to which the notification-type discovery is applied as the discovery method amongst configuration information items of the corresponding collection target apparatus.

Using the above-described information, the discovery method is automatically updated for each configuration information item.

<Processes Executed by Apparatuses of Second Embodiment>

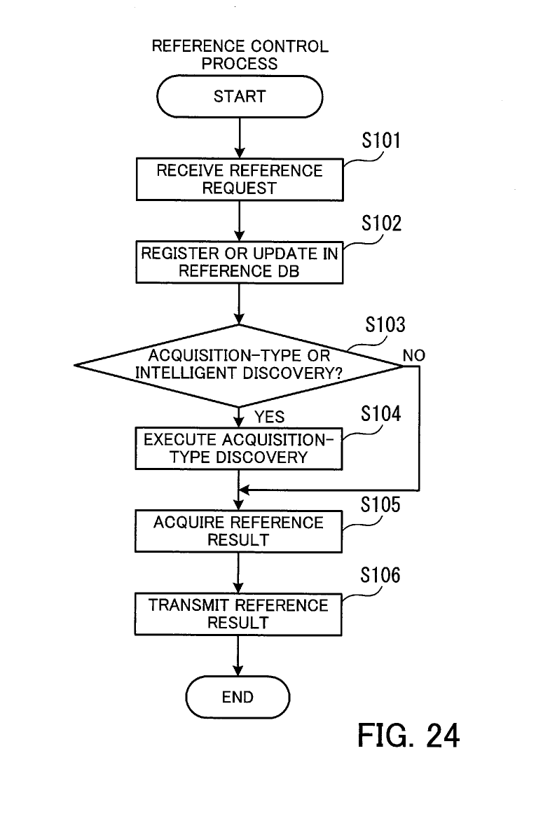

Next described are procedures executed by the configuration management server 100 and the collection target apparatuses 200, 300, and 400 to automatically determine an appropriate discovery method. A reference process is first described. FIG. 24 is a flowchart illustrating an example of a procedure for a reference process.

[Step S101] The reference control unit 121 receives a configuration information reference request output from the reference apparatus 30 (the terminal 31 or the cloud system 32).

[Step S102] The reference control unit 121 registers a record in the reference database 123, or updates a record within the reference database 123 to thereby reflect content (“when” and “which configuration information item” was referred to) of the reference request in the reference database 123. For example, if a record corresponding to a configuration information item sought by the received reference request is not found in the reference database 123, the reference control unit 121 adds and registers the record according to the reference request in the reference database 123. In this regard, the current date and time are set in a corresponding field within the latest reference date and time column. A corresponding field within the previous reference date and time is left blank.

If the record corresponding to a configuration information item sought by the received reference request is found in the reference database 123, the reference control unit 121 updates content of the record. For example, the reference control unit 121 sets the value found within the latest reference date and time column, corresponding to the referred-to configuration information item, in a corresponding field within the previous reference date and time column. Then, the reference control unit 121 sets the current date and time in the field within the latest reference date and time column.

Further, the reference control unit 121 transfers the reference request to the acquisition-type discovery executing unit 127.

[Step S103] The acquisition-type discovery executing unit 127 determines whether the discovery method adopted for the configuration information item sought by the reference request is the acquisition-type discovery or the intelligent discovery. For example, referring to the discovery method storing unit 125a, the acquisition-type discovery executing unit 127 identifies, within the discovery method management table 125b, a record corresponding to the referred-to configuration information item based on a set of the name of a collection target apparatus and the name of the configuration information item indicated by the reference request. Then, the acquisition-type discovery executing unit 127 ascertains a discovery method set for the identified record. If the discovery method is the acquisition-type discovery or intelligent discovery, the process proceeds to step S104. If the discovery method is the notification-type discovery, the process proceeds to step S105.

[Step S104] When the discovery method is the acquisition-type discovery or intelligent discovery, the acquisition-type discovery executing unit 127 executes the acquisition-type discovery. For example, the acquisition-type discovery executing unit 127 transmits a configuration information acquisition request designating the referred-to configuration information item to the collection target apparatus indicated by the reference request. In response to the acquisition request, the collection engine of the collection target apparatus acquires the designated configuration information item and returns it to the configuration management server 100 as a response. The returned configuration information item is stored in the CMDB 110 via the update control unit 122.

[Step S105] The reference control unit 121 acquires, from the CMDB 110, the configuration information item designated by the reference request.

[Step S106] The reference control unit 121 transmits the acquired configuration information item to the reference apparatus 30 having issued the reference request.

In the above-described manner, when the discovery method adopted for the configuration information item sought by the reference request is the acquisition-type discovery or intelligent discovery, the acquisition-type discovery is executed. Then, the configuration information item with the latest value is returned in response to the reference request.

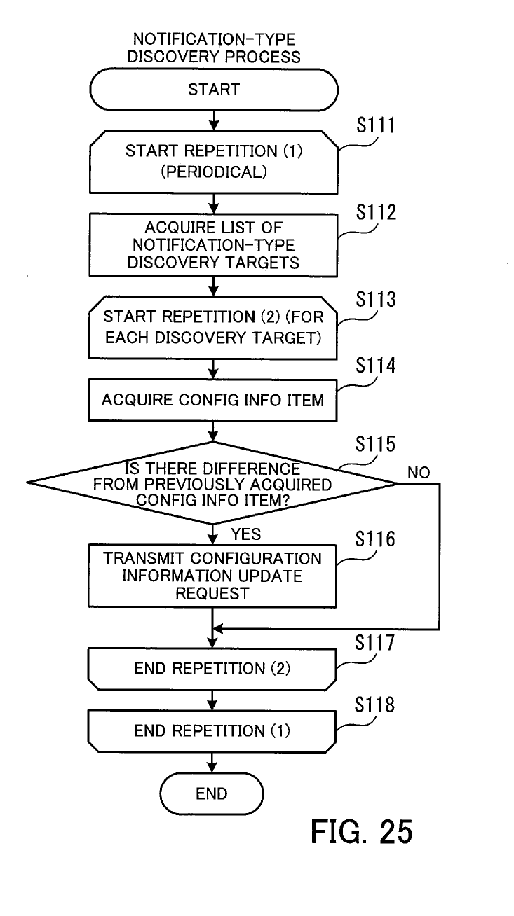

Next described is a procedure of the notification-type discovery process. FIG. 25 is a flowchart illustrating an example of a procedure for a notification-type discovery process. The following description is given assuming that the collection target apparatus 200 executes the notification-type discovery.

[Step S111] The notification-type discovery executing unit 212 periodically repeats steps S112 to S117.

[Step S112] The notification-type discovery executing unit 212 acquires, from the notification-type discovery target storing unit 211, a list of notification-type discovery target configuration information items.

[Step S113] The notification-type discovery executing unit 212 repeats steps S114 to S116 for each of the discovery target configuration information items.

[Step S114] The notification-type discovery executing unit 212 acquires a corresponding configuration information item set in the collection target apparatus 200.

[Step S115] The notification-type discovery executing unit 212 determines if there is a difference from a previously acquired configuration information item. For example, each time acquiring a configuration information item, the notification-type discovery executing unit 212 stores the configuration information item. Then, if the value of the configuration information item acquired this time is different from the value of the previously acquired configuration information item, the notification-type discovery executing unit 212 determines that there is a difference. If there is a difference, the process proceeds to step S116. If not, the process proceeds to step S117.

[Step S116] When there is a difference, the notification-type discovery executing unit 212 transmits a configuration information update request to the configuration management server 100. The update request to be transmitted includes the updated configuration information item.

[Step S117] If steps S114 to S116 have been carried out for all the notification-type discovery target configuration information items, the notification-type discovery executing unit 212 proceeds to step S118.

[Step S118] The notification-type discovery executing unit 212 ends the process when receiving an instruction to end the notification-type discovery process, for example, a processing stop instruction issued by the collection engine 210. If no such instruction has been issued, steps S112 to S117 are periodically repeated.

As described above, the notification-type discovery process runs a processing loop according to the number of configuration information items having adopted the notification-type discovery. Therefore, an increased number of configuration information items adopting the notification-type discovery results in higher processing load associated with the notification-type discovery process, such as monitoring whether each configuration information item has been updated.

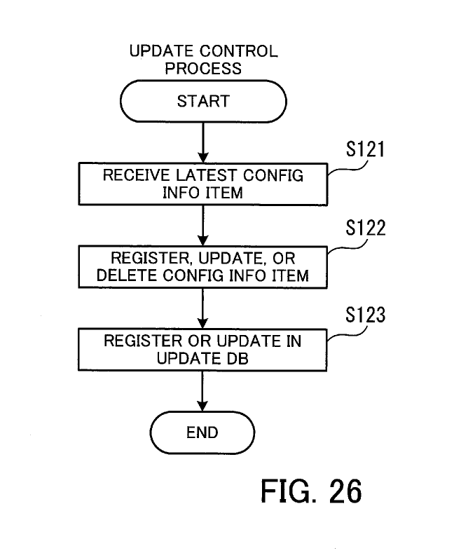

Next described is a procedure of an update control process executed upon reception of an update request. FIG. 26 is a flowchart illustrating an example of a procedure for an update control process.

[Step S121] The update control unit 122 receives an update request including the latest configuration information item from the collection target apparatus 200/300/400.

[Step S122] The update control unit 122 registers, in the CMDB 110, the configuration information item indicated in the received update request, or updates a configuration information item within the CMDB 110 based on the configuration information item. Note that in the case of receiving, in place of the configuration information item, information indicating an absence of a configuration information item, the update control unit 122 deletes a corresponding configuration information item from the CMDB 110.

[Step S123] The update control unit 122 registers a record in the update database 124, or updates a record within the update database 124 to thereby reflect content (“when” and “which configuration information item” was updated) of the update request in the update database 124. For example, if a record corresponding to the received configuration information item is not found in the update database 124, the update control unit 122 adds and registers a record according to the received configuration information item in the update database 124. In this regard, the update control unit 122 sets the current date and time in a corresponding field within the latest update date and time. A corresponding field within the previous reference date and time is left blank.

If the record corresponding to the received configuration information item is found in the update database 124, the update control unit 122 updates content of the record. For example, the update control unit 122 sets the value found within the latest update date and time column, corresponding to the configuration information item, in a corresponding field within the previous update date and time column. Then, the update control unit 122 sets the current date and time in the field within the latest update date and time.

Thus, in the case where a configuration information item is updated, information on the updated date and time of the configuration information item is also updated.

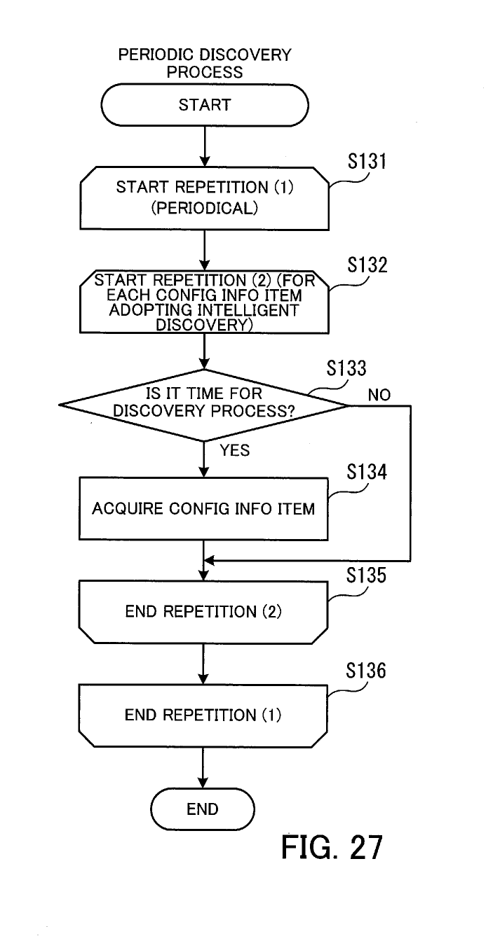

Next described is a procedure of a periodic discovery process. FIG. 27 is a flowchart illustrating an example of a procedure for a periodic discovery process.

[Step S131] The periodic discovery executing unit 128 periodically repeats steps S132 to S135.

[Step S132] The periodic discovery executing unit 128 repeats steps S133 and S134 for each configuration information item whose discovery method is designated as the intelligent discovery in the discovery method storing unit 125a.

[Step S133] The periodic discovery executing unit 128 determines whether it is the time for a discovery process. For example, referring to the schedule column in the discovery method management table 125b, the periodic discovery executing unit 128 determines the time of a discovery process set for the configuration information item. Then, the periodic discovery executing unit 128 compares the scheduled discovery time and the current time, and determines that it is the time for a discovery process when the scheduled discovery time arrives. If the scheduled discovery time has arrived, the process proceeds to step S134. If not, the process proceeds to step S135.

[Step S134] When the discovery time scheduled for the configuration information item has arrived, the periodic discovery executing unit 128 acquires, from a collection target apparatus having the configuration information item, the latest configuration information item. According to the acquired configuration information item, content of the CMDB 110 is updated.

[Step S135] If steps S133 and S134 have been carried out for all the configuration information items whose discovery method is designated as the intelligent discovery, the periodic discovery executing unit 128 proceeds to step S136.

[Step S136] The periodic discovery executing unit 128 ends the process when receiving an instruction to end the configuration information collecting process, for example, a processing stop instruction issued by the autonomous collection engine 120. If no such instruction has been issued, steps S132 to S135 are periodically repeated.

In the above-described manner, the periodic discovery is implemented for each configuration information item adopting the intelligent discovery.

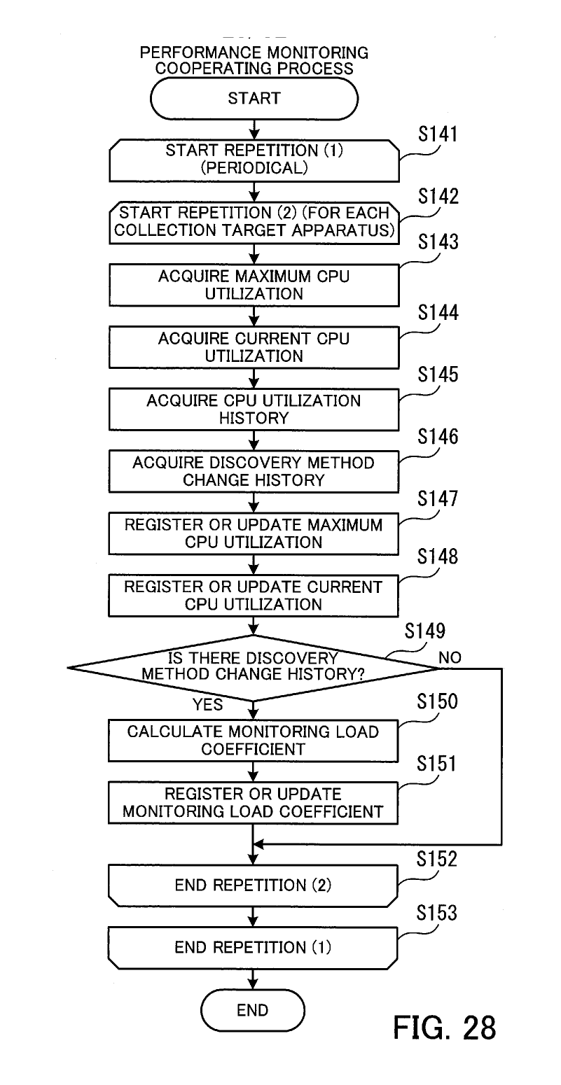

Next described is a performance monitoring cooperation process. FIG. 28 is a flowchart illustrating an example of a procedure for a performance monitoring cooperation process.

[Step S141] The performance monitoring cooperating unit 129 periodically repeats the performance monitoring cooperation process composed of steps S142 to S152.

[Step S142] For each of the collection target apparatuses 200, 300, and 400, the performance monitoring cooperating unit 129 carries out a registration/update process for the performance management table 129b, composed of steps S143 to S151.

[Step S143] The performance monitoring cooperating unit 129 acquires, from the performance monitoring unit 130, the maximum CPU utilization of the collection target apparatus to be processed.

[Step S144] The performance monitoring cooperating unit 129 acquires, from the performance monitoring unit 130, the current CPU utilization of the collection target apparatus.

[Step S145] The performance monitoring cooperating unit 129 acquires the CPU utilization history of the collection target apparatus from the performance monitoring unit 130.

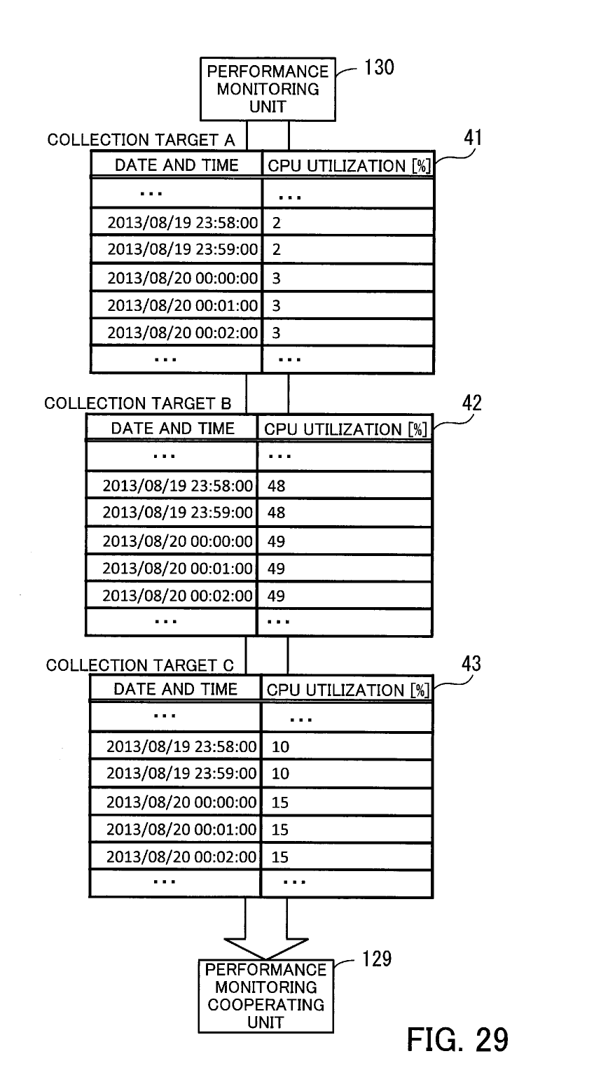

FIG. 29 illustrates an example of a CPU utilization history provided by a performance monitoring unit. For example, the performance monitoring unit 130 periodically acquires CPU utilization from each of the collection target apparatuses 200, 300, and 400. The performance monitoring unit 130 adds the date and time (time stamp) of the acquisition to each acquired CPU utilization, and stores in the memory 102 as CPU utilization histories 41 to 43 according to each of the collection target apparatuses 200, 300, and 400. Then, in response to a request from the performance monitoring cooperating unit 129, the performance monitoring unit 130 transmits the CPU utilization history 41/42/43. Based on the acquired CPU utilization history 41/42/43, the performance monitoring cooperating unit 129 is able to determine “when” and “how” the CPU utilization has been changed. Now let us return to FIG. 28.

[Step S146] The performance monitoring cooperating unit 129 acquires, from the discovery method change log storing unit 126, a discovery method change history of the collection target apparatus. The acquired discovery method change history is a record on the collection target apparatus, stored in the discovery method change log 126a. Based on the acquired change history, the performance monitoring cooperating unit 129 is able to determine “when” and “how” discovery methods have been changed. Note that the performance monitoring cooperating unit 129 may acquire only a change history registered in the discovery method change log 126a after the previous acquisition.

[Step S147] The performance monitoring cooperating unit 129 registers the acquired maximum CPU utilization of the collection target apparatus in the performance management table 129b of the performance information storing unit 129a. Note that if a value is already registered for the maximum CPU utilization in the performance management table 129b, the performance monitoring cooperating unit 129 updates the registered value with the newly acquired maximum CPU utilization.

[Step S148] The performance monitoring cooperating unit 129 registers the acquired current CPU utilization of the collection target apparatus in the performance management table 129b of the performance information storing unit 129a. Note that if a value is already registered for the current CPU utilization in the performance management table 129b, the performance monitoring cooperating unit 129 updates the registered value with the newly acquired current CPU utilization.

[Step S149] The performance monitoring cooperating unit 129 determines the presence or absence of a discovery method change history of the collection target apparatus. If there is a change history, the process proceeds to step S150. If not, the process proceeds to step S152.

[Step S150] The performance monitoring cooperating unit 129 calculates a monitoring load coefficient of the collection target apparatus. For example, the performance monitoring cooperating unit 129 extracts, from the discovery method change history of the collection target apparatus, configuration information items whose discovery method has been changed from the acquisition-type discovery or the intelligent discovery to the notification-type discovery. Note that the monitoring load coefficient is calculated from the CPU utilization history and the discovery method change history. For example, the performance monitoring cooperating unit 129 first acquires, from the discovery method change history, the “number” of configuration information items whose discovery method was changed to the notification-type discovery and the “date and time” of the change. Next, the performance monitoring cooperating unit 129 acquires, from the CPU utilization history, a “change in the CPU utilization” having the same date and time as the “date and time” of the change to the notification-type discovery. Then, the performance monitoring cooperating unit 129 divides the obtained “change in the CPU utilization” by the “number” of the configuration information items whose discovery method was changed to the notification-type discovery. The division result represents the increase rate of CPU utilization when the number of configuration information items adopting the notification-type discovery is increased by one. The increase rate of CPU utilization is used as the monitoring load coefficient.

[Step S151] The performance monitoring cooperating unit 129 registers the monitoring load coefficient of the collection target apparatus in the performance management table 129b of the performance information storing unit 129a. Note that a value is already registered for the monitoring load coefficient in the performance management table 129b, the performance monitoring cooperating unit 129 updates the registered value with the newly calculated monitoring load coefficient.

[Step S152] If steps S143 to S151 have been carried out for all the collection target apparatuses 200, 300, and 400, the performance monitoring cooperating unit 129 proceeds to step S153.

[Step S153] The performance monitoring cooperating unit 129 ends the process when receiving an instruction to end the performance monitoring cooperation process, for example, a process stop instruction issued by the autonomous collection engine 120. If no such instruction has been issued, steps S142 to S152 are periodically repeated.

Thus, the performance information of each of the collection target apparatuses 200, 300, and 400 is stored in the performance information storing unit 129a.

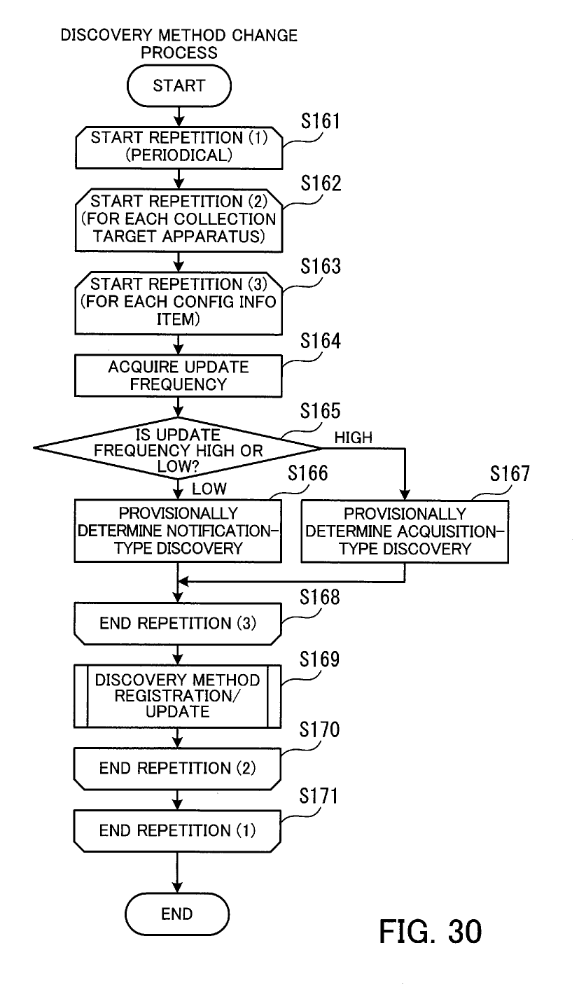

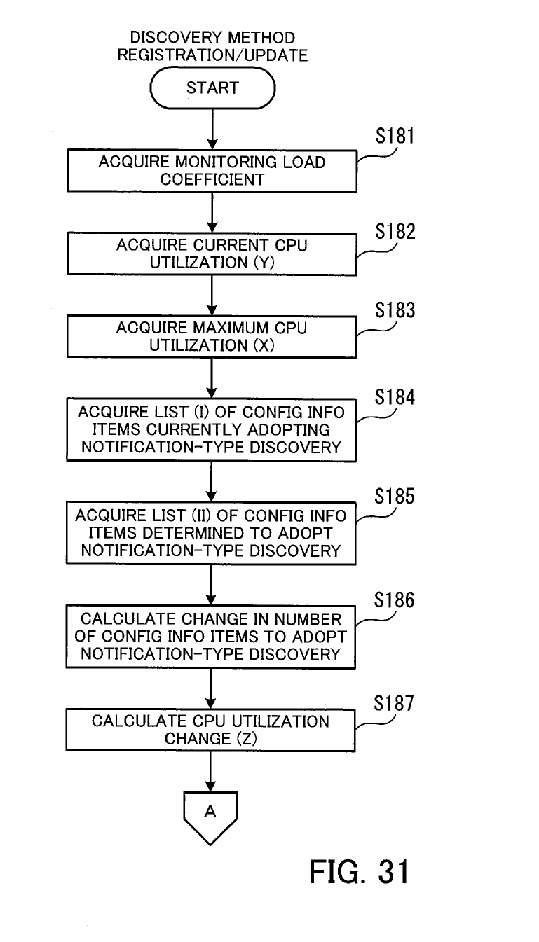

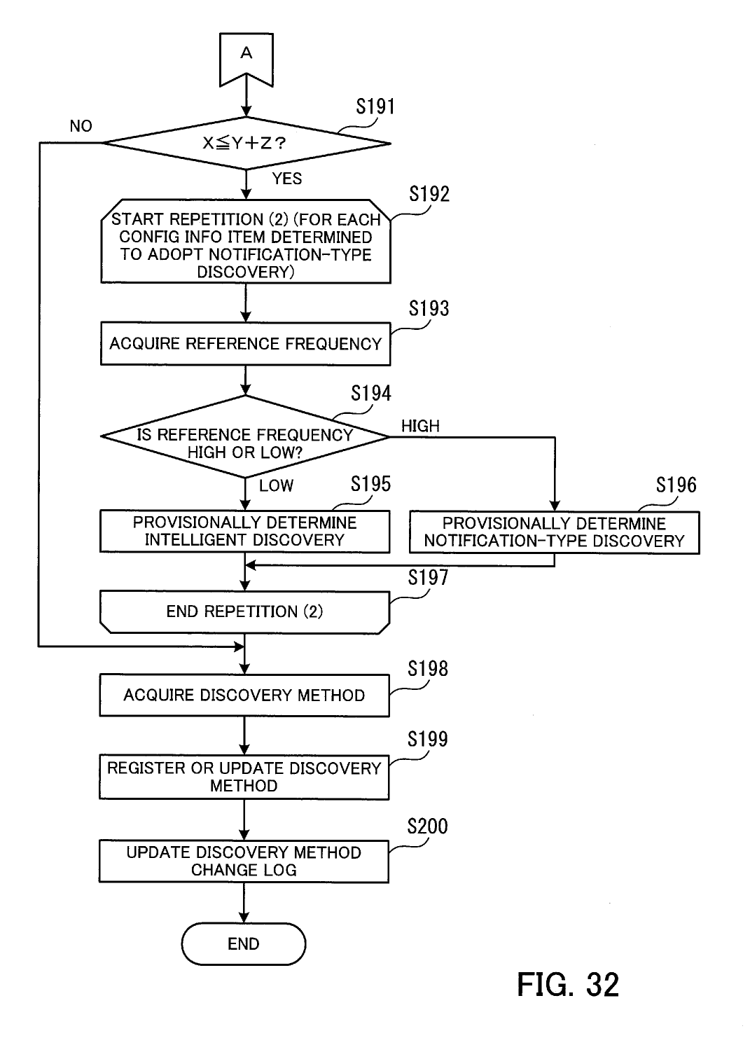

Next described is a procedure for a discovery method change process. FIG. 30 is a flowchart illustrating an example of a procedure for a discovery method change process.

[Step S161] The discovery method changing unit 125 periodically repeats a discovery method change process composed of steps S162 to S170.

[Step S162] For each of the collection target apparatuses 200, 300, and 400, the discovery method changing unit 125 repeats a registration/update process of information stored in the discovery method management table 125b of the discovery method storing unit 125a.

[Step S163] The discovery method changing unit 125 repeats a discovery method determination process composed of steps S164 to S167 for each configuration information item to be processed.

[Step S164] The discovery method changing unit 125 acquires, from the update database 124, information indicating the update frequency of the configuration information item. For example, the discovery method changing unit 125 acquires, from the update database 124, the latest update date and time and the previous update date and time of the configuration information item. Then, the discovery method changing unit 125 uses the value obtained by subtracting the previous update date and time from the latest update date and time as the update frequency of the configuration information item.

[Step S165] The discovery method changing unit 125 determines whether the update frequency of the configuration information item is higher or lower than a predetermined value. For example, the discovery method changing unit 125 determines that the update frequency is high if the frequency exceeds once per hour, and determines that the update frequency is low if the frequency is less than or equal to once per hour. The case where the update frequency exceeds once per hour is when the value obtained by subtracting the previous update date and time from the latest update date and time is less than or equal to one hour. In addition, the case where the update frequency is less than or equal to once per hour is when the value obtained by subtracting the previous update date and time from the latest update date and time exceeds one hour. If the update frequency is high, the process proceeds to step S167. If the update frequency is low, the process proceeds to step S166.

[Step S166] When the update frequency is low, the discovery method changing unit 125 provisionally determines the notification-type discovery as the discovery method for the configuration information item to adopt. The discovery method changing unit 125 stores the provisionally determined discovery method, for example, in a discovery method temporary storage area provided in the memory 102. Subsequently, the process proceeds to step S168.

[Step S167] When the update frequency is high, the discovery method changing unit 125 provisionally determines the acquisition-type discovery as the discovery method for the configuration information item to adopt. The discovery method changing unit 125 stores the provisionally determined discovery method, for example, in the discovery method temporary storage area of the memory 102.

[Step S168] If the discovery method determination process in steps S164 to S167 has been carried out for all the configuration information items to be processed, the discovery method changing unit 125 proceeds to step S169. If one or more configuration information items remain unprocessed, the discovery method changing unit 125 repeats steps S164 to S167 for each of the unprocessed configuration information items.

[Step S169] The discovery method changing unit 125 carries out a discovery method registration/update process. Details of the process are described later (see FIGS. 31 and 32).

[Step S170] If steps S163 to S169 have been carried out for all the collection target apparatuses 200, 300, and 400, the discovery method changing unit 125 proceeds to step S171. If one or more collection target apparatuses remain untreated, the discovery method changing unit 125 repeats steps S163 to S169 for each of the untreated collection target apparatuses.

[Step S171] The discovery method changing unit 125 ends the process when receiving an instruction to end the discovery method change process, for example, a process stop instruction issued by the autonomous collection engine 120. If no such instruction has been issued, steps S162 to S170 are periodically repeated.

The discovery method registration/update process is described next in detail. FIG. 31 is a first half of a flowchart illustrating an example of a procedure for a discovery method registration/update process.

[Step S181] The discovery method changing unit 125 acquires the monitoring load coefficient of a collection target apparatus currently being processed from the performance information storing unit 129a.

[Step S182] The discovery method changing unit 125 acquires the current CPU utilization of the collection target apparatus from the performance information storing unit 129a. The discovery method changing unit 125 sets the acquired CPU utilization as a variable Y.

[Step S183] The discovery method changing unit 125 acquires the maximum CPU utilization of the collection target apparatus from the performance information storing unit 129a. The discovery method changing unit 125 sets the acquired maximum CPU utilization as a variable X.

[Step S184] The discovery method changing unit 125 acquires, from the discovery method storing unit 125a, a list (I) of configuration information items currently adopting the notification-type discovery amongst configuration information items of the collection target apparatus.

[Step S185] The discovery method changing unit 125 acquires a list (II) of configuration information items provisionally determined to adopt the notification-type discovery amongst the configuration information items of the collection target apparatus. The configuration information item list (II) is acquired, for example, from the discovery method temporary storage area in the memory 102, used in step S166 above.

[Step S186] The discovery method changing unit 125 calculates a change in the number of configuration information items adopting the notification-type discovery amongst the configuration information items of the collection target apparatus. For example, the discovery method changing unit 125 subtracts the number of configuration information items included in the list (I) from the number of those included in the list (II), and uses the division result as the change in the number. The division result being a positive value means an increase in the number of configuration information items to adopt notification-type discovery. On the other hand, the division result being a negative value means a decrease in the number of configuration information items to adopt notification-type discovery.

[Step S187] The discovery method changing unit 125 calculates a change in the CPU utilization of the collection target apparatus. For example, the discovery method changing unit 125 calculates a CPU utilization change [%] using the change in the number of configuration information items to adopt the notification-type discovery and the monitoring load coefficient of the collection target apparatus. Specifically, the CPU utilization change [%] is obtained by multiplying the change in the number of configuration information items to adopt the notification-type discovery by the monitoring load coefficient. The calculation result being a positive value means an increase in the CPU utilization, and the calculation result being a negative value means a decrease in the CPU utilization. The discovery method changing unit 125 sets the calculate CPU utilization change as a variable Z. Subsequently, the process proceeds to step S191 (see FIG. 32).

FIG. 32 is a second half of the flowchart illustrating the example of the procedure for the discovery method registration/update process.

[Step S191] The discovery method changing unit 125 compares the maximum CPU utilization (X) of the collection target apparatus and a CPU utilization prediction value which is obtained by adding the CPU utilization change (Z) to the current CPU utilization (Y). If the CPU utilization prediction value is more than or equal to the maximum CPU utilization, the process proceeds to step S192. If the CPU utilization prediction value is less than the maximum CPU utilization, the process proceeds to step S198.

[Step S192] When the CPU utilization prediction value is more than or equal to the maximum CPU utilization (X≧Y+Z), the discovery method changing unit 125 carries out a discovery method determination process composed of steps S193 to S196 for each configuration information item determined to adopt the notification-type discovery.

[Step S193] The discovery method changing unit 125 acquires, from the reference database 123, the reference frequency of a configuration information item being processed.

[Step S194] The discovery method changing unit 125 determines whether the reference frequency of the configuration information item is high or low. For example, the discovery method changing unit 125 determines that the reference frequency is high if the frequency exceeds once per hour, and determines that the reference frequency is low if the frequency is less than or equal to once per hour. The case where the reference frequency exceeds once per hour is when the value obtained by subtracting the previous reference date and time from the latest reference date and time is less than or equal to one hour. In addition, the case where the reference frequency is less than or equal to once per hour is when the value obtained by subtracting the previous reference date and time from the latest reference date and time exceeds one hour. If the reference frequency is high, the process proceeds to step S196. If the reference frequency is low, the process proceeds to step S195.

[Step S195] When the reference frequency is low, the discovery method changing unit 125 provisionally determines the intelligent discovery as the discovery method for the configuration information item to adopt. That is, when the CPU utilization prediction value is more than or equal to the maximum CPU utilization and the reference frequency of the configuration information item is low, the intelligent discovery is provisionally determined as the discovery method of the configuration information item. The discovery method changing unit 125 stores the provisionally determined discovery method, for example, in the discovery method temporary storage area of the memory 102. Subsequently, the process proceeds to step S197.

[Step S196] When the reference frequency is high, the discovery method changing unit 125 provisionally determines the notification-type discovery as the discovery method for the configuration information item to adopt. That is, when the CPU utilization prediction value is more than or equal to the maximum CPU utilization and the reference frequency of the configuration information item is high, the notification-type discovery is provisionally determined as the discovery method of the configuration information item. The discovery method changing unit 125 stores the provisionally determined discovery method, for example, in the discovery method temporary storage area of the memory 102.

[Step S197] If steps S193 to S196 have been carried out for all the configuration information items to be processed, the discovery method changing unit 125 proceeds to step S198. If one or more configuration information items remain unprocessed, the discovery method changing unit 125 repeats steps S193 to S196 for each of the unprocessed configuration information items.

[Step S198] The discovery method changing unit 125 acquires, from the discovery method temporary storage area, a list of provisionally determined discovery methods for individual configuration information items of the collection target apparatus.

[Step S199] The discovery method changing unit 125 registers the discovery methods of the individual configuration information items of the collection target apparatus in the discovery method management table 125b. Note that in the case where a record is already registered for a corresponding one of the configuration information items in the discovery method management table 125b, the discovery method changing unit 125 updates the discovery method of the record.

[Step S200] The discovery method changing unit 125 updates the discovery method change log 126a. For example, the discovery method changing unit 125 stores, in the discovery method change log 126a, a record where a discovery method before the change, the changed discovery method, and the date and time of the change are added to the set of the name of the collection target apparatus and the configuration information item.

In the above-described manner, it is possible to dynamically change a discovery method to thereby reduce load on the system. In addition, the second embodiment allows an appropriate discovery method to be determined for each configuration information item, enabling flexible setting of discovery methods.

Further, in the case where the load of a collection target apparatus is about to exceed a predetermined value, the number of configuration information items adopting the notification-type discovery is prevented from increasing further. As a result, the monitoring load on the collection target apparatus attributed to an increase in the number of configuration information items adopting the notification-type discovery is reduced, which in turn prevents the collection target apparatus from being put under excessive load.

While, as described above, the embodiments have been exemplified, the configurations of individual portions illustrated in the embodiments may be replaced with others having the same functions. In addition, another constituent element or process may be added thereto. Furthermore, two or more compositions (features) of the embodiments may be combined together.

According to one aspect, it is possible to control the load attributable to the acquisition of the latest configuration information items.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A configuration management apparatus for managing a configuration of a collection target apparatus by acquiring a value of a configuration information item from the collection target apparatus, the configuration management apparatus comprising:
a processor that performs a procedure including:
determining an acquisition timing of acquiring the configuration information item based on at least one of reference frequency of the configuration information item being referred to, update frequency of the value of the configuration information item being updated, and load on the collection target apparatus in such a manner as to control the load on the collection target apparatus; and
acquiring the configuration information item from the collection target apparatus at the determined acquisition timing through cooperation with the collection target apparatus.

2. The configuration management apparatus according to claim 1, wherein:
the determining includes determining the acquisition timing amongst a first timing, a second timing, and a third timing, the first timing being a time when a reference request to refer to the configuration information item is input, the second timing being a time when the value of the configuration information item is updated, and the third timing being a time according to a predetermined schedule and a time when the reference request for the configuration information item is input.

3. The configuration management apparatus according to claim 1, wherein:
the determining includes determining, when the update frequency is more than a predetermined value, a time when a reference request to refer to the configuration information item is input as the acquisition timing, and determining, when the update frequency is less than or equal to the predetermined value, a time when the value of the configuration information item is updated as the acquisition timing.

4. The configuration management apparatus according to claim 1, wherein:
the determining includes determining, when the reference frequency is less than or equal to a predetermined value, a time according to a predetermined schedule and a time when a reference request to refer to the configuration information item is input as the acquisition timing, and determining, when the reference frequency is more than the predetermined value, a time when the value of the configuration information item is updated as the acquisition timing.

5. The configuration management apparatus according to claim 1, wherein:
the determining includes determining, when the load on the collection target apparatus is more than a predetermined value, a time according to a predetermined schedule and a time when a reference request to refer to the configuration information item is input as the acquisition timing, and determining, when the load on the collection target apparatus is less than or equal to the predetermined value, a time when the value of the configuration information item is updated as the acquisition timing.

6. The configuration management apparatus according to claim 1, wherein:
the determining includes determining the acquisition timing depending on combination of the reference frequency, the update frequency, and the load on the collection target apparatus.

7. The configuration management apparatus according to claim 1, wherein:
the determining includes determining, when the configuration information item is provided in plurality, the acquisition timing for each of the plurality of configuration information items, and
the acquiring includes acquiring each of the plurality of configuration information items at the acquisition timing determined for the configuration information item.

8. The configuration management apparatus according to claim 7, wherein:
the determining includes:
calculating an increase in the load on the collection target apparatus when, amongst the plurality of configuration information items, a number of configuration information items whose acquisition timing is a time when the value of each of the configuration information items is updated increases by one based on change in the number of configuration information items whose acquisition timing is the time when the value of each of the configuration information items is updated and change in the load on the collection target apparatus, and
preventing, when a value obtained by adding the calculated increase to the load on the collection target apparatus at present is more than or equal to a predetermined value, an increase in the number of configuration information items whose acquisition timing is the time when the value of each of the configuration information items is updated.

9. A configuration management system comprising:
a collection target apparatus from which a configuration information item is to be collected; and
a configuration management apparatus that acquires a value of the configuration information item from the collection target apparatus to manage a configuration of the collection target apparatus, wherein:
the configuration management apparatus determines an acquisition timing of acquiring the configuration information item based on at least one of reference frequency of the configuration information item being referred to, update frequency of the value of the configuration information item being updated, and load on the collection target apparatus in such a manner as to control the load on the collection target apparatus, and acquires the configuration information item from the collection target apparatus at the determined acquisition timing through cooperation with the collection target apparatus, and
the collection target apparatus transmits the configuration information item to the configuration management apparatus at the determined acquisition timing through cooperation with the configuration management apparatus.

10. A non-transitory computer-readable storage medium storing a computer program that causes a computer to perform a procedure for acquiring a value of a configuration information item from a collection target apparatus to manage a configuration of the collection target apparatus, the procedure comprising:
determining an acquisition timing of acquiring the configuration information item based on at least one of reference frequency of the configuration information item being referred to, update frequency of the value of the configuration information item being updated, and load on the collection target apparatus in such a manner as to control the load on the collection target apparatus; and
acquiring the configuration information item from the collection target apparatus at the determined acquisition timing through cooperation with the collection target apparatus.
